(19) United States
(12) Patent Application Publication
(10) Pub. No.: US 2026/0046723 A1
(43) Pub. Date: Feb. 12, 2026

(54) CSI MEASUREMENTS FOR INTER-CELL MOBILITY

(71) Applicant: TELEFONAKTIEBOLAGET LM ERICSSON (PUBL), Stockholm (SE)

(72) Inventors: Icaro Leonardo Da Silva, SOLNA (SE); Jens Bergqvist, LINKÖPING (SE); Claes Tidestav, BÅLSTA (SE); Antonino Orsino, KIRKKONUMMI (FI)

(21) Appl. No.: 19/101,286

(22) PCT Filed: Aug. 8, 2023
(86) PCT No.: PCT/IB2023/058009

§ 371 Date: Feb. 5, 2025

Related U.S. Application Data
(60) Provisional application No. 63/396,140, filed on Aug. 8, 2022.

(51) Int. Cl. H04W 36/08; H04W 36/00

(52) U.S. Cl. CPC H04W 36/087; H04W 36/0085

(57) ABSTRACT

According to some embodiments, a method is performed by a wireless device for performing channel state information (CSI) measurements for layer one (L1)/layer two (L2) inter-cell mobility. The method comprises receiving a message from a network node. The message comprises at least one configuration of a target L1/L2 inter-cell mobility candidate cell. The method further comprises: performing CSI measurements on at least one of a synchronization signal (SS) and a reference signal (RS) of the target L1/L2 inter-cell mobility candidate cell based on the at least one configuration of the target L1/L2 inter-cell mobility candidate cell and transmitting a CSI report including information based on the CSI measurements to the network node.

### TECHNICAL FIELD

Embodiments of the present disclosure are directed to wireless communications and, more particularly, to channel state information (CSI) measurements for inter-cell mobility.

### BACKGROUND

In a wireless communication network, such as a Third Generation Partnership Project (3GPP) fifth generation (5G) network, to support beam management operation, a user equipment (UE) is configured by the network with a channel state information (CSI) measurement configuration (e.g., the information element (IE) CSI-MeasConfig received within an RRCReconfiguration message). The CSI measurement configuration is configured per serving cell (within ServingCellConfig, e.g., of an SpCell) to associate the cell in which CSI reports are to be transmitted.

For each type of CSI report the UE transmits, the network indicates an explicit list of CSI resources (also referred to as CSI resource configuration(s)) comprising a list of CSI-RSs sets (nzp-CSI-RS-ResourceSetList, IE SEQUENCE (SIZE (1 . . . maxNrofNZP-CSI-RS-ResourceSetsPerConfig)) OF NZP-CSI-RS-ResourceSetId) and/or SSBs sets (csi-SSB-ResourceSetList, IE SEQUENCE (SIZE (1 . . . maxNrofCSI-SSB-ResourceSetsPerConfig)) OF CSI-SSB-ResourceSetId) for a given serving cell for which the UE is configured, e.g., the SpCell of a cell group, or an SCell.

The IE in which the CSI resource configuration(s) is provided to the UE is reproduced below:

CSI-ResourceConfig information element

-- ASN1START
-- TAG-CSI-RESOURCECONFIG-START

| CSI-ResourceConfig ::= | SEQUENCE { | |
|---|---|---|
| csi-ResourceConfigId | CSI-ResourceConfigId, | |
| csi-RS-ResourceSetList | CHOICE { | |
| nzp-CSI-RS-SSB | | SEQUENCE { |

| | |
|---|---|
| nzp-CSI-RS-ResourceSetList | SEQUENCE (SIZE (1..maxNrofNZP-CSI-RS- |

ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM-ResourceSetsPerConfig)) |

OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

CSI-ResourceConfig field descriptions

bwp-Id
The DL BWP which the CSI-RS associated with this CSI-ResourceConfig are located in (see
TS 38.214, clause 5.2.1.2.
csi-IM-ResourceSetList
List of references to CSI-IM resources used for CSI measurement and reporting in a CSI-RS
resource set. Contains up to maxNrofCSI-IM-ResourceSetsPerConfig resource sets if
resourceType is ‘aperiodic’ and 1 otherwise (see TS 38.214, clause 5.2.1.2).
csi-ResourceConfigId
Used in CSI-ReportConfig to refer to an instance of CSI-ResourceConfig.
csi-SSB-ResourceSetList
List of references to SSB resources used for CSI measurement and reporting in a CSI-RS
resource set (see TS 38.214, clause 5.2.1.2).
nzp-CSI-RS-ResourceSetList
List of references to NZP CSI-RS resources used for beam measurement and reporting in a
CSI-RS resource set. Contains up to maxNrofNZP-CSI-RS-ResourceSetsPerConfig resource
sets if resourceType is ‘aperiodic’ and 1 otherwise (see TS 38.214, clause 5.2.1.2).
resourceType
Time domain behavior of resource configuration (see TS 38.214, clause 5.2.1.2). It does not
apply to resources provided in the csi-SSB-ResourceSetList.

In summary, to perform CSI measurements supporting network beam management operations (e.g., beam switching, activation and/or deactivation of transmission configuration indicator (TCI) states) the UE is configured with an explicit list of CSI-RS resources and/or SSBs per serving cell to be measured and reported.

3GPP standards activity includes a work item on further New Radio (NR) mobility enhancements for layer one (L1)/layer two (L2) based inter-cell mobility (see RP-213565 for further details). According to the work item description, when a UE moves from the coverage area of one cell to another cell, at some point a serving cell change is performed. Currently, serving cell change is triggered by L3 measurements and is done by radio resource control (RRC) signaling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling to reduce latency, overhead and interruption time.

L1-L2 inter-cell mobility should be like inter-cell beam management, i.e., to support L1-L2 inter-cell mobility, the UE should be configured to perform measurements on cells that are not the serving cells as defined up to Rel-17.

In Rel-17, to support inter-physical cell identifier (PCI) multiple transmission/reception point (mTRP) operation, a CSI resource may be associated to a PCI that is not the same PCI of one of the serving cells. This solution requires the UE to receive an explicit indication of which beams (SSBs) and PCIs are to be measured for a given reporting configuration.

A goal is to specify procedures for L1/L2 based inter-cell mobility for mobility latency reduction. These include: configuration and maintenance for multiple candidate cells to facilitate fast application of configurations for candidate cells; a dynamic switch mechanism among candidate serving cells (including SpCell and SCell) for the potential applicable scenarios based on L1/L2 signaling; L1 enhancements for inter-cell beam management, including L1 measurement and reporting, and beam indication; timing advance management; and central unit (CU)-distributed unit (DU) interface signaling to support L1/L2 mobility, if needed.

The procedure of L1/L2 based inter-cell mobility is applicable to the following scenarios: standalone, carrier aggregation (CA) and NR-dual connectivity (DC) case with serving cell change within one cell group (CG; intra-DU case and intra-CU inter-DU case (applicable for standalone and CA, no new RAN interfaces are expected); both intra-frequency and inter-frequency; and both frequency range one (FR1) and frequency range two (FR2). Source and target cells may be synchronized or non-synchronized.

There currently exist certain challenges. For example, a problem with existing solutions for configuring CSI resources for a UE for CSI measurements to assist the network to perform beam management operations (e.g., SSBs and/or CSI-RSs measurements for TCI state activation/deactivation) is that CSI resources are limited to be configured for serving cell(s) in the cell group in which the configuration is included, i.e., current PCell and configured SCell(s). Such a solution does not work properly for L1/L2 inter-cell mobility because the UE should be configured to measure SSBs and/or CSI-RSs of a L1/L2 inter-cell mobility candidate cell that may be a cell that is not one of the currently defined serving cells (e.g., not a PCell), but possibly a cell in the same frequency as the serving cell.

3GPP Rel-17 includes a solution to configure the UE to perform CSI measurements on SSBs of a PCI that is not a PCI of one of the serving cells for which the UE is configured by configuring an IE CSI-SSB-ResourceSet as follows:

CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF |

```
SSB-Index,
    ...,
    [[
```

| | |
|---|---|
| additionalPCIList-r17 | SEQUENCE (SIZE(1..maxNrofCSI-SSB-ResourcePerSet)) OF |
| AdditionalPCIIndex-r17 OPTIONAL | -- Need R |

]]
}
-- TAG-CSI-SSB-RESOURCESET-STOP
-- ASN1STOP

CSI-SSB-ResourceSet field descriptions

additionalPCIList
Indicates the physical cell IDs (PCI) of the SSBs in the
csi-SSB-ResourceList. If present, the list has the same
number of entries as csi-SSB-ResourceList.

For the Rel-17 solution for multiple TRPs, the UE receives a CSI resource configuration (CSI-ResourceConfig) associated with a resource set (CSI-SSB-ResourceSet), wherein each resource set includes a list of SSB indexes, associated to SSBs which may be from different PCIs. For example, if csi-SSB-ResourceList=[SSB index-7, SSB index-3, SSB index-7] and additionalPCIList-r17=[3 5 6], the UE is configured with:
SSB index-7 of the PCI indexed=3;
SSB index-3 of the PCI indexed=5;
SSB index-7 of the PCI indexed=6;

The CSI resource configuration may include resources for more than one PCI, but the CSI-SSB-ResourceSet IE is generated by the serving DU, because the solution is meant to be specified only for intra-DU scenarios, i.e., multiple TRPs but within the same DU. In Rel-18, the UE may be configured with a L1/L2 inter-cell mobility candidate from a neighbor DU (e.g., in the same CU as the serving DU), and the UE should be configured to perform measurements of candidate cells of a neighbor DU. Because the current CSI resource configuration is part of the CSI-MeasConfig within CellGroupConfig of a serving cell configuration of the serving DU, it is not clear how the UE can be configured with these CSI resources associated with candidate cells of neighbor DUs.

### SUMMARY

As described above, certain challenges currently exist with channel state information (CSI) measurements for inter-cell mobility. Certain aspects of the present disclosure and their embodiments may provide solutions to these or other challenges. For example, in particular embodiments a user equipment (UE) performs measurements to assist the network to trigger layer one (L1)/layer 2 (L2) inter-cell mobility, for one or more target candidate cells, based on the target candidate configuration(s), wherein the at least one configuration of a target L1/L2 inter-cell mobility candidate cell is generated by a candidate distributed unit (DU) (e.g., different from the serving DU).

This is different from the solutions described above wherein measurements are determined based on the serving cell configuration (as generated by a serving DU, as in existing solution single DU is assumed) for which the UE is configured (CSI-MeasConfig within a serving cell configuration the UE is configured with and communicating with).

Particular embodiments comprise a method at a UE for performing channel state information (CSI) measurements for L1/L2 inter-cell mobility. The method comprises receiving a Radio Resource Control (RRC) message from a network node. The RRC message comprising at least one configuration of a target L1/L2 inter-cell mobility candidate cell. The method further comprises applying the configuration from the RRC message and in response transmitting an RRC complete message to the network node. Upon applying the configuration in the RRC message, the method comprises performing CSI measurements on at least one synchronization signal (SS) and/or or a reference signal (RS) of the target L1/L2 inter-cell mobility candidate cell based on the at least one configuration of a target L1/L2 inter-cell mobility candidate cell. The method further comprises transmitting a CSI report including information based on the CSI measurements on the at least one SS and/or or RS to the network node.

Some embodiments include determining a frequency. For example, some embodiments further comprise the UE performing the at least one CSI measurement on at least one SS (e.g., synchronization signal block (SSB)) and/or at least one RS (CSI-RS) based on at least one frequency information of a SS and/or or a RS of the L1/L2 inter-cell mobility candidate cell.

Some embodiments include the UE obtaining the at least one frequency information of a SS and/or or a RS of the L1/L2 inter-cell mobility candidate cell by: (explicit) receiving a CSI measurement configuration in the RRC message, for a currently active serving cell; and/or (explicit) receiving an RRM measurement configuration in the RRC message, wherein the frequency information is associated to a measurement object that comprises a frequency information, e.g. SSB frequency; and/or (implicit) receiving the configuration of a target L1/L2 inter-cell mobility candidate cell.

In particular embodiments, the configuration of a target L1/L2 inter-cell mobility candidate cell comprises the configuration the UE uses in the target cell after L1/L2 inter-cell mobility execution, wherein that is the configuration to either be applied, or switched to, or activated by the UE upon reception from the network of a L1/L2 inter-cell mobility command, wherein the L1/L2 inter-cell mobility command comprises a lower layer signaling (e.g., medium access control (MAC) control element (CE) or downlink control indication (DCI)) indicating to the UE the execution of L1/L2 inter-cell mobility to the L1/L2 inter-cell mobility candidate cell.

In particular embodiments, the configuration of a target L1/L2 inter-cell mobility candidate cell comprises at least one or more of: beam configuration(s), wherein a beam configuration comprises a beam identifier; SS index(es) and/or one or more RS identifier(s); transmission configuration indicator (TCI) state configuration(s), wherein a TCI state configuration comprises an associated RS identifier and/or an SS index; quasi-colocation (QCL) configuration(s), wherein a QCL configuration comprises an associated RS identifier and/or an SS index; TCI state configuration(s), wherein a TCI state configuration comprises an associated QCL configuration with an associated RS identifier and/or an SS index; cell identifier(s) (physical cell identity); CSI measurement configuration, comprising one or more CSI resource configuration(s), wherein a CSI resource configuration indicates at least one SS index and/or at least one RS identifier to be measured when the UE operates in the target L1/L2 inter-cell mobility candidate cell; and frequency information for transmission of the SSs and/or the RSs of the target cell (e.g. SSB frequency, CSI-RS initial frequency, CSI-RS number of physical resource blocks, CSI-RS offset to an absolute frequency like point A as defined in TS 38.331).

In particular embodiments, the method further comprises performing at least one CSI measurement on the SS and/or RS based on the at least one frequency information of the SS and/or or the RS by performing cell search to the cell of the cell identifier configured within the configuration of a target L1/L2 inter-cell mobility candidate cell, and upon detecting the cell, performing the at least one CSI measurement on an SS and/or an RS of the cell.

In particular embodiments, the method further comprises performing at least one CSI measurement on the SS and/or RS based on the at least one frequency information of the SS and/or or the RS for the SS(s) and RS(s) which are part of the beam configuration(s) of the configuration of a target L1/L2 inter-cell mobility candidate cell.

Some embodiments include determining the SS(s)/RS(s) for which to perform measurements. For example, in some embodiments the UE performs CSI measurements for transmitting a CSI report to the network on at least one SS and/or at least one RS indicated in the configuration of a target L1/L2 inter-cell mobility candidate cell.

In some embodiments, the UE performs CSI measurements (and reports CSI measurements) on at least one SS and/or at least one RS configured as QCL source(s) of the TCI states that are part of the configuration of a target L1/L2 inter-cell mobility candidate cell.

In some embodiments, the UE performs CSI measurements (and reports CSI measurements) on at least one SS and/or at least one RS configured as QCL source(s) of the TCI states and indicated to be measured, wherein the at least one SS and/or the at least one RS are a subset of the SSs and/or RSs configured as QCL sources of the configured TCI state configurations which are part of the configuration of a target L1/L2 inter-cell mobility candidate cell.

In some embodiments, the UE performs CSI measurements (and reports CSI measurements) on at least one SS and/or at least one RS configured in a CSI measurement configuration within the configuration of the target L1/L2 inter-cell mobility candidate cell.

Some embodiments include determining the candidate cell(s) for which to perform measurements. For example, in some embodiments the UE performs CSI measurements for transmitting a CSI report to the network on at least one cell whose cell identifier (e.g., PCI) is indicated in the configuration of a target L1/L2 inter-cell mobility candidate cell.

In some embodiments, the UE performs CSI measurements (and reports CSI measurements) on one cell whose cell identifier is indicated in the Serving Cell Configuration Common (e.g., IE ServingCellConfigCommon), which is part of the configuration of a target L1/L2 inter-cell mobility candidate cell.

In some embodiments, the configuration of a target L1/L2 inter-cell mobility candidate cell is generated by a candidate distributed unit (DU) of the radio access network (RAN), wherein the candidate DU corresponds to a neighbor DU for a candidate cell of the neighbor DU and/or to a serving DU for a candidate cell of the neighbor DU.

In some embodiments, the method comprises transmitting the CSI report including information based on the CSI measurements on the at least one SS and/or or RS to the network node based on one or more reporting criteria. The one or more reporting criteria may be configured in a CSI reporting configuration.

In some embodiments, the method further comprises receiving a message indicating the removal of at least one of the configured target candidate cells for L1/L2 inter-cell mobility for which the UE has been performing measurements based on the configuration of the target L1/L2 inter-cell mobility candidate, e.g., according to any of the methods described herein; and, as the cell is removed, the configuration of the target L1/L2 inter-cell mobility candidate is deleted and the UE stops performing measurements performed according to one of the methods.

Some embodiments are performed by a central unit (CU). According to some embodiments, a method at a CU of a RAN (e.g., gNodeB-CU) for configuring CSI measurements for a UE being configured with L1/L2 based inter-cell mobility comprises transmitting a request message to a DU of the RAN (e.g., gNodeB-DU), indicating a request for the DU to configure the UE with L1/L2 based inter-cell mobility. The request is a for a cell in a frequency that is indicated in the message. The method further comprises receiving from the DU, in response to the second message, a response message including at least one configuration of a L1/L2 based inter-cell mobility candidate cell in the frequency indicated in the message.

The method further comprises: generating an RRC Reconfiguration to be provided to the UE, comprising a CSI measurement configuration comprising the frequency information of the L1/L2 based inter-cell mobility candidate cell in which the UE needs to find the SSs and RSs in which the UE performs CSI measurements; transmitting to the DU a message comprising an RRC Reconfiguration to be transmitted to the UE; and receiving from the DU a message comprising an RRC Reconfiguration Complete from the UE. Further CU actions are described in more detail below.

Some embodiments are performed by a candidate DU. For example, a method at a candidate DU of a RAN (e.g., gNodeB-DU) for configuring L1/L2 based inter-cell mobility for a UE in RRC_CONNECTED comprises receiving a request message from a CU of the RAN (e.g., gNodeB-CU), indicating a request for the DU to configure the UE with L1/L2 based inter-cell mobility. The request is a for a cell in a frequency which is indicated in the message. The method further comprises transmitting to the CU, in response to the second message, a response message including at least one configuration of a L1/L2 based inter-cell mobility candidate cell in the frequency indicated in the message. The one configuration of a L1/L2 based inter-cell mobility candidate cell is to be used by the UE for performing CSI measurements on at least one SS and/or or RS of the target L1/L2 inter-cell mobility candidate cell while the UE is still connected to the serving cell which is not the target L1/L2 inter-cell mobility candidate cell, in preparation to L1/L2 inter-cell mobility execution.

FIG. 1 is a flow diagram illustrating a summary of the L1/L2 inter-cell mobility execution, according to particular embodiments. FIG. 1 illustrates the interactions between UE, CU, Serving DU and Candidate DU.

In general, particular embodiments include a UE receiving an RRC message including the configuration of a target L1/L2 inter-cell mobility candidate cell and, based on that configuration, which may be primarily used for operating with the target cell after execution on reception of a lower layer signaling, the UE determines on which SS and/or RSs and which cell(s) the UE shall perform CSI measurements.

In some embodiments, the UE determines the SSs (e.g., SSB indexes) and/or RSs (CSI-RS resource identifiers) to perform CSI measurements to be the SSs and RSs configured within the configuration of a target L1/L2 inter-cell mobility candidate cell as the QCL source(s) of the configured TCI states of the target L1/L2 inter-cell mobility candidate cell. In other words, the UE performs CSI measurements on the beams indicated in the configuration of a target L1/L2 inter-cell mobility candidate cell as candidate beams for L1/L2 inter-cell mobility execution. A benefit is that the UE reduces the number of SSs and RSs on which the UE is required to perform CSI measurements for CSI reporting for L1/L2 inter-cell mobility.

In some embodiments, the UE determines the cell (e.g., physical cell identity, encoded in one or more SSs, like PSS/SSS) to perform CSI measurements to be the cell configured within the configuration of a target L1/L2 inter-cell mobility candidate cell. In other words, the UE perform CSI measurements on the cell whose PCI is indicated in the configuration of a target L1/L2 inter-cell mobility candidate cell.

In some embodiments, the UE determines the frequency of the SSs and/or RSs (e.g., SSB frequency and/or CSI-RS frequencies) to perform CSI measurements to be the frequency of the SSs and/or RSs configured within the configuration of a target L1/L2 inter-cell mobility candidate cell. In another alternative, the frequency of the SSs and/or RSs (e.g., SSB frequency and/or CSI-RS frequencies) is configured explicitly, as part of a CSI measurement configuration.

The term “applicable cells” refers to the cells on which the UE measures CSI, i.e., the cells of the SSs and RSs that the UE measure CSI, for CSI reporting to assist L1/L2 inter-cell mobility. The term “applicable beams” refers to the SSs and RSs for which the UE measures CSI, i.e., the SSs and RSs that the UE measure CSI, for CSI reporting to assist L1/L2 inter-cell mobility.

In general, a method is performed by a wireless device for performing CSI measurements for L1/L2 inter-cell mobility. The method comprises receiving a message from a network node. The message comprises at least one configuration of a target L1/L2 inter-cell mobility candidate cell. The method further comprises: performing CSI measurements on at least one of a SS and a RS of the target L1/L2 inter-cell mobility candidate cell based on the at least one configuration of the target L1/L2 inter-cell mobility candidate cell and transmitting a CSI report including information based on the CSI measurements to the network node.

According to some embodiments, a wireless receiver comprises processing circuitry operable to perform any of the methods of the wireless device and/or UE described above.

Also disclosed is a computer program product comprising a non-transitory computer readable medium storing computer readable program code, the computer readable program code operable, when executed by processing circuitry to perform any of the methods performed by the wireless device and/or UE described above.

According to some embodiments, a method is performed by a network node operating as a CU of a radio access network (RAN) for configuring CSI measurements for a wireless device configured with L1/L2 based inter-cell mobility. The method comprises transmitting a request message to a DU of the RAN indicating a request for the DU to configure the wireless device with L1/L2 based inter-cell mobility. The request is a for a cell in a frequency that is indicated in the request message. The method further comprises: receiving from the DU, in response to the request message, a response message including at least one configuration of a L1/L2 based inter-cell mobility candidate cell in the frequency indicated in the message; generating a RRC Reconfiguration to be provided to the wireless device comprising a CSI measurement configuration comprising the frequency information of the L1/L2 based inter-cell mobility candidate cell in which the wireless device is to find a SS or RS on which the wireless device performs CSI measurements; and transmitting to the DU a message comprising the RRC Reconfiguration to be transmitted to the wireless device.

According to some embodiments, a network node comprises processing circuitry operable to perform any of the methods of the network node CU and/or DU described above.

Also disclosed is a computer program product comprising a non-transitory computer readable medium storing computer readable program code, the computer readable program code operable, when executed by processing circuitry to perform any of the methods performed by the network nodes described above.

Certain embodiments may provide one or more of the following technical advantages. For example, in particular embodiments a UE performs CSI measurements for CSI reporting to support L1/L2 inter-cell mobility based on a configuration of a target L1/L2 inter-cell mobility candidate cell, without the need of a CSI measurement configuration generated by the candidate DU and/or the serving DU. This is a significant advantage in an intra-CU inter-DU scenario, wherein the L1/L2 inter-cell mobility candidate is configured by a neighbor DU.

One reason for such benefit is that the neighbor DU generates the configuration of a target L1/L2 inter-cell mobility candidate cell to be applied and/or to be switched to upon L1/L2 inter-cell mobility execution, which includes the cell identity of the target candidate that the UE uses to limit the number of cells in a given frequency (e.g., SSB frequency) for which it needs to perform CSI measurements. That benefits the UE, which performs fewer measurements, and more relevant measurements, because the cells the UE measures are the cells configured as candidates, because the cell identifiers were determined based on the configuration of the target L1/L2 inter-cell mobility candidate cells.

Similarly, the configuration of the target L1/L2 inter-cell mobility candidate cell also includes the identifiers and indexes of the configured beams (i.e., RSs identifiers and SSs indexes of RSs and SSs transmitted in beams of the candidate cell, in different spatial directions) that the UE uses to limit the number of SSs and RSs in a given frequency (e.g., SSB frequency) for which it needs to perform CSI measurements. That also benefits the UE, which performs fewer measurements, and more relevant measurements in a given cell because the SSs and RSs that the UE measures are the SSs and RSs of the target candidate cell, which may be indicated during beam switching.

Another advantage is that because the UE determines what to measure in terms of cells and SSs and RSs of a cell based on the target L1/L2 inter-cell mobility configuration, the candidate DU is not required to generate an explicit CSI measurement configuration to configure the UE during the preparation phase, when L1/L2 inter-cell mobility is being configured (e.g., a UE specific CSI resource configuration) including an explicit list of SS indexes and RS identifiers, which simplifies the candidate DU implementation; or, generates a very limited CSI measurement configuration, such as the frequency(ies) information of SSs and RSs (e.g., E-absolute radio frequency channel number (ARFCN) of SSB frequency, ARFCN of point A, offset to point A for CSI-RS initial resources, CSI-RS bandwidth, etc.), to be used by the UE with the configuration of a target L1/L2 inter-cell mobility candidate cell, to limit the number of CSI measurements the UE performs (and cells in which the UE perform CSI measurements) to the candidate cells the UE is configured with, and the SSs/RSs configured as beams (e.g., QCL source in a TCI state configuration) of the target candidate cell, if the UE executes L1/L2 inter-cell mobility to that candidate cell.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a flow diagram illustrating a summary of the L1/L2 inter-cell mobility execution, according to particular embodiments;

FIG. 2 is a block diagram illustrating an architecture for a central unit (CU) and a distributed unit (DU) in a radio access network (RAN);

FIG. 3 illustrates an example of how a user equipment (UE) may receive a frequency information for channel state information (CSI) measurements for a synchronization signal (SS) and/or a reference signal (RS) of a L1/L2 inter-cell mobility candidate;

FIG. 4 illustrates another example of how a UE may receive a frequency information for CSI measurements for SS and/or RS of a L1/L2 inter-cell mobility candidate;

FIG. 5 illustrates an example of how the UE may receive indications of which SSs and/or RSs for CSI measurements of a L1/L2 inter-cell mobility candidate;

FIG. 6 illustrates another example of how a UE may receive indications of which SSs and/or RSs for CSI measurements of a L1/L2 inter-cell mobility candidate;

FIG. 7 illustrates an example of how a UE may receive indications of which cells to measure for CSI measurements i.e., which L1/L2 inter-cell mobility candidate(s)/PCI of the candidates;

FIG. 8 illustrates common parameters across master cell group candidates;

FIG. 9 is a flow diagram illustrating an example of a signaling flow when the candidate DU is a neighbor DU;

FIG. 10 is a flow diagram illustrating an example of a signaling flow showing the procedure between a serving DU in configuring the mapping between CSI report configuration and each L1/L2 inter-cell mobility candidate(s) from neighbor DU, so the UE knows what CSI report configuration is associated to SSs and/or RSs and/or cells to be measured CSI and reported;

FIG. 11 is a flow diagram illustrating an example of a signaling flow when the candidate DU is a serving DU;

FIG. 12 is a flow diagram illustrating an example of a signaling flow for multiple candidate DU(s), with at least the serving DU and one or more neighbor DU(s);

FIG. 13 illustrates an example communication system, according to certain embodiments;

FIG. 14 illustrates an example user equipment (UE), according to certain embodiments;

FIG. 15 illustrates an example network node, according to certain embodiments;

FIG. 16 illustrates a block diagram of a host, according to certain embodiments;

FIG. 17 illustrates a virtualization environment in which functions implemented by some embodiments may be virtualized, according to certain embodiments;

FIG. 18 illustrates a host communicating via a network node with a UE over a partially wireless connection, according to certain embodiments;

FIG. 20 illustrates a method performed by a network node central unit (CU), according to certain embodiments; and

FIG. 21 illustrates a method performed by a network node distributed unit (DU), according to certain embodiments.

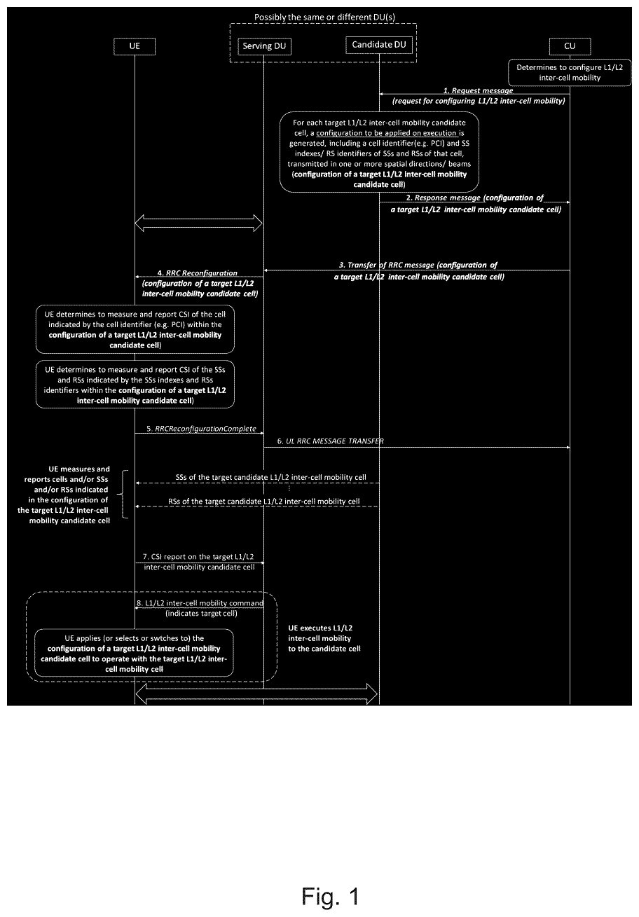

### DETAILED DESCRIPTION

As described above, certain challenges currently exist with channel state information (CSI) measurements for inter-cell mobility. Certain aspects of the present disclosure and their embodiments may provide solutions to these or other challenges. For example, in particular embodiments a user equipment (UE) performs measurements to assist the network to trigger layer one (L1)/layer 2 (L2) inter-cell mobility, for one or more target candidate cells, based on the target candidate configuration(s), wherein the at least one configuration of a target L1/L2 inter-cell mobility candidate cell is generated by a candidate distributed unit (DU) (e.g., different from the serving DU).

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

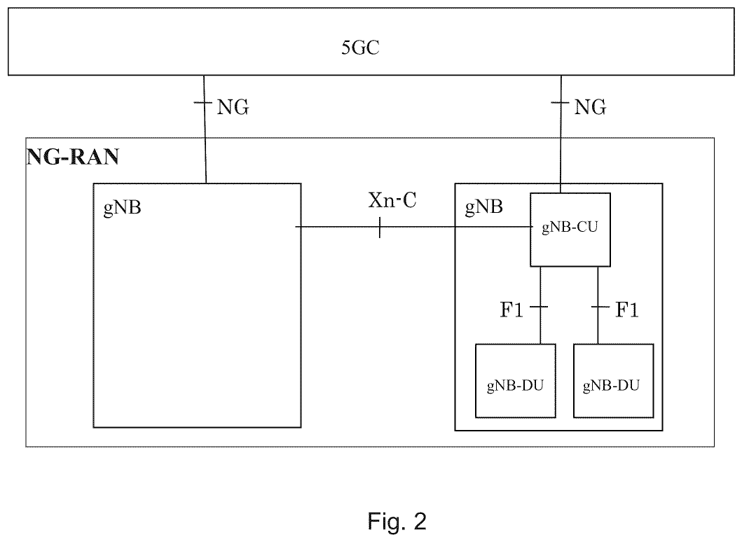

FIG. 2 is a block diagram illustrating an architecture for a central unit (CU) and a DU in a radio access network (RAN). In the illustrated example, the RAN is a next-generation RAN (NG-RAN), which may be referred as the 5G RAN, however, the method is applicable to any RAN such as a sixth generation (6G) RAN architecture. The illustrated example includes the architecture (with both NG-RAN and 5GC) with NG-RAN split in CU and DU connected via F1 interface.

The RAN (e.g., NG-RAN) consists of a set of RAN nodes (e.g., gNBs) connected to a core network (CN) (e.g., a 5GC) through a RAN/CN interface (e.g., NG interface). For NG-RAN, that may comprise one or more ng-eNBs, wherein an ng-eNB may consist of an ng-eNB-CU and one or more ng-eNB-DU(s). A gNB may consist of a gNB-CU and one or more gNB-DU(s). A gNB-CU and a gNB-DU are connected via F1 interface. A gNB-DU may be connected to multiple gNB-CUs. Particular embodiments are presented herein as applicable to the NG-RAN as an example, however, the embodiments are also applicable to any RAN architecture, such as a 6G RAN.

The term “L1/L2 based inter-cell mobility” is used in the work item description in 3GPP, though interchangeably the terms L1/L2 mobility, L1-mobility, L1 based mobility, L1/L2-centric inter-cell mobility or L1/L2 inter-cell mobility may be used. The basic principle is that the UE receives a lower layer signaling from the network indicating to the UE a change (or switch or activation) of its serving cell (e.g., change of PCell, from a source to a target PCell), wherein a lower layer signaling is a message/signaling of a lower layer protocol.

A lower layer protocol refers to a lower layer protocol in the air interface protocol stack compared to Radio Resource Control (RRC) protocol, e.g. medium access control (MAC) is considered a lower layer protocol because it is below RRC in the air interface protocol stack, and in this case a lower layer signaling/message may correspond to a MAC control element (MAC CE). Another example of lower layer protocol is the Layer 1 (or Physical Layer, L1), and in this case a lower layer signaling/message may correspond to a downlink control information (DCI).

Signaling information in a protocol layer lower than RRC reduces the processing time and, consequently, reduces the interruption time during mobility. In addition, it may also increase the mobility robustness because the network may respond to faster changes in the channel conditions.

Another relevant aspect in L1/L2 inter-cell mobility is that in a multiple-beam scenario, a cell may be associated to multiple synchronization signal blocks (SSBs), and during a half-frame, different SSBs may be transmitted in different spatial directions (i.e., using different beams, spanning the coverage area of a cell). Similar reasoning may be applicable to channel state information reference signal (CSI-RS) resources, which may also be transmitted in different spatial directions. Thus, in L1/L2 inter-cell mobility, the reception of a lower layer signaling indicates the UE to change from one beam in the serving cell to another beam in a neighbor cell (which is a configured candidate cell), and thus changing serving cell.

The text refers to the term “L1/L2 inter-cell mobility candidate cell” to refer to a cell the UE is configured with when configured with L1/L2 inter-cell mobility. That is a cell the UE can move to in a L1/L2 inter-cell mobility procedure, upon reception of a lower layer signaling. These cells may also be referred to as candidate cells, candidates, mobility candidates, non-serving cells, additional cells, etc. This is a cell the UE performs measurements on (e.g., CSI measurements) as disclosed herein, so that the UE reports these measurements and the network may make an educated decision on which beam (e.g., transmission configuration indicator (TCI) state) and/or cell the UE is to be switched.

A L1/L2 inter-cell mobility candidate cell may be a candidate to be a target PCell or PSCell, or an SCell of a cell group (e.g., MCG SCell). In that sense, when the text refers to a resource configuration to indicate synchronization signals (SSs) and/or reference signals (RSs) for the UE to measure for CSI for reporting, it may be referring to SSs and/or RSs of a candidate SCell of the master cell group (MCG), a candidate SCell of the secondary cell group (SCG), a candidate PSCell and/or a candidate PCell.

A CSI measurement is a measurement based on which the UE derives information to include in a CSI report. A CSI measurement is different from a radio resource management (RRM) measurement reported on an RRC MeasurementReport message. An RRM measurement is configured by an RRC measurement configuration (IE MeasConfig in the first ASN.1 level in the RRCReconfiguration message), is Layer 3 filtered, is used as input to trigger an RRC Measurement Report (which is an RRC message), and once reported, is typically used by the network (e.g., the CU) to determine whether the UE needs to be handed over to another cell, with a Reconfiguration with Sync procedure. In the context of the embodiments described herein, a CSI measurement is configured by a CSI measurement configuration (e.g., CSI-MeasConfig-L1-L2-Mobility), is not necessarily Layer 3 filtered by the UE, is not used as input to trigger an RRC Measurement Report (which is an RRC message), but instead is used as input to derive information that is included in a CSI report, which is fundamentally different than an RRC Measurement report, because a CSI report is not an RRC message, but a message in a layer lower than RRC in the protocol stack, e.g. Physical Layer/Layer 1 (L1), such as a CSI report over physical uplink control channel (PUCCH) and/or physical uplink shared channel (PUSCH) similar to the one(s) defined in TS 38.214, but possibly including information of L1/L2 inter-cell mobility candidate cells. After a CSI report is reported, it is typically used by the network (e.g., the DU) to determine whether the UE needs to be switched to a beam (and/or SSB, TCI state, quasi-colocated (QCL) source) of a candidate cell, in a L1/L2 inter-cell mobility execution procedure.

In one set of embodiments, a CSI measurement comprises one or more of the following. The CSI measurement may comprise a synchronization signal reference signal received power (SS-RSRP) of a L1/L2 inter-cell mobility candidate cell for at least one configured/indicated SSB of the L1/L2 inter-cell mobility candidate cell. The SS-RSRP is measured only among the reference signals corresponding to SS/PBCH blocks (SSBs) with the same SS/PBCH block (SSB) index and the same physical-layer cell identity (PCI) of the L1/L2 inter-cell candidate cell.

In some embodiments, the SS-RSRP may be derived as the linear average over the power contributions (in [W]) of the resource elements that carry secondary synchronization signals (SSSs) of the L1/L2 inter-cell candidate cell.

In some embodiments, the SS-RSRP determination is based on the demodulation reference signals for physical broadcast channel (PBCH) of the L1/L2 inter-cell candidate cell; and, if indicated by higher layers, CSI reference signals of the L1/L2 inter-cell candidate cell, in addition to secondary synchronization signals may be used.

In some embodiments, the SS-RSRP indicates certain SS/PBCH blocks for performing SS-RSRP measurements, then SS-RSRP is measured only from the indicated set of SS/PBCH block(s).

In some embodiments, the SS-RSRP is used for L1-RSRP to be included in a CSI report.

The CSI measurement may comprise a SS reference signal received quality (SS-RSRQ) of a L1/L2 inter-cell mobility candidate cell, for at least one configured/indicated SSB of the L1/L2 inter-cell mobility candidate cell.

The CSI measurement may comprise a SS signal-to-noise and interference ratio (SS-SINR) of a L1/L2 inter-cell mobility candidate cell, for at least one configured/indicated SSB of the L1/L2 inter-cell mobility candidate cell.

The CSI measurement may comprise a CSI reference signal received power (CSI-RSRP) of a L1/L2 inter-cell mobility candidate cell, for at least one configured/indicated CSI-RS resource of the L1/L2 inter-cell mobility candidate cell.

In some embodiments, the CSI-RSRP comprises the linear average over the power contributions (in [W]) of the resource elements of the antenna port(s) that carry CSI reference signals configured for RSRP measurements within the considered measurement frequency bandwidth in the configured CSI-RS occasions, for the L1/L2 inter-cell mobility candidate cell.

The CSI measurement may comprise a CSI reference signal received quality (CSI-RSRQ) of a L1/L2 inter-cell mobility candidate cell, for at least one configured/indicated CSI-RS resource of the L1/L2 inter-cell mobility candidate cell.

The CSI measurement may comprise a CSI signal-to-noise and interference ratio (CSI-SINR) of a L1/L2 inter-cell mobility candidate cell, for at least one configured/indicated CSI-RS resource of the L1/L2 inter-cell mobility candidate cell.

The CSI measurement may comprise a Layer 1 reference signal received power (L1-RSRP) based on at least one SSB of a L1/L2 inter-cell mobility candidate cell.

The CSI measurement may comprise a L1-RSRP based on at least one CSI-RS resource of a L1/L2 inter-cell mobility candidate cell.

The CSI measurement may comprise a Layer 1 SINR (L1-SINR) based on at least one SSB of a L1/L2 inter-cell mobility candidate cell.

The CSI measurement may comprise a L1-SINR based on at least one CSI-RS resource of a L1/L2 inter-cell mobility candidate cell.

The CSI measurement may comprise a channel quality indicator (CQI) of a L1/L2 inter-cell mobility candidate cell, based on SSB and/or CSI-RS in the CSI resource configuration;

The CSI measurement may comprise a precoding matrix indicator (PMI) of a L1/L2 inter-cell mobility candidate cell, based on SSB and/or CSI-RS in the CSI resource configuration;

The CSI measurement may comprise a CSI-RS resource indicator (CRI) of a L1/L2 inter-cell mobility candidate cell, based on SSB and/or CSI-RS in the CSI resource configuration;

The CSI measurement may comprise a SS/PBCH block resource indicator (SSBRI) of a L1/L2 inter-cell mobility candidate cell, based on SSB and/or CSI-RS in the CSI resource configuration;

The CSI measurement may comprise a Layer indicator (L1) of a L1/L2 inter-cell mobility candidate cell, based on SSB and/or CSI-RS in the CSI resource configuration;

The CSI measurement may comprise a rank indicator (RI) of a L1/L2 inter-cell mobility candidate cell, based on SSB and/or CSI-RS in the CSI resource configuration.

In a set of embodiments, the reporting criteria for reporting the CSI comprises one or more of: periodic, aperiodic, semi-persistent, for which the UE transmits the CSI report.

In a set of embodiments, the reporting configuration comprises one or more of: a configuration of physical uplink channel such as PUCCH and/or PUSCH where the UE transmits a CSI report; and configuration of one or more reporting quantity(ies) to be measured and included in the CSI report, such as RI, CQI, SSBRI, CRI, L1-RSRP, L1-RSRQ, L1-SINR based on SSB(s) and/or CSI-RS resource(s) of a L1/L2 inter-cell mobility candidate cell.

Some embodiments include UE embodiments. In a set of embodiments, the UE receives an RRC message from a network node comprising at least one configuration of a target L1/L2 inter-cell mobility candidate cell. The RRC message may correspond to an RRC Reconfiguration message (e.g., RRCReconfiguration, as defined in TS 38.331). The message may be received by the UE after the UE has transmitted an RRC measurement report (e.g., MeasurementReport message defined in TS 38.331).

The measurement report may include one or more cells (e.g., cell A, cell B) indicating the cells are possible candidate cells for L1/L2 inter-cell mobility (e.g., good enough coverage, RSRP above a threshold) so that the at least one configuration of a target L1/L2 inter-cell mobility candidate cell is for cell A and/or cell B.

The RRC Reconfiguration message may be the first RRC Reconfiguration message the UE receives after security is activated and/or after the UE transitions to RRC_CONNECTED.

In a set of embodiments, the UE receives at least one configuration of a L1/L2 based inter-cell mobility candidate cell, generated by a candidate DU (which may be a serving DU or neighbor DU). Based on the configuration, the UE performs CSI measurements on at least one SS and/or or RS of the target L1/L2 inter-cell mobility candidate cell and transmits a CSI report including information based on the CSI measurements on the at least one SS and/or or RS to the network node.

The SS may correspond to a SSB, as defined in TS 38.331, TS 38.330, TS 38.211, TS 38.213, or another SS block with similar properties, such as the ones as follows. The SSB may encode a physical cell identity (e.g., an identifier using a number of bits). The SSB may be transmitted in a set (or burst) wherein for each half-frame a set of SSBs are transmitted in different time domain resources and/or different spatial directions (e.g., with different spatial domain properties, sometimes referred to as beams). The SSB may also be referred to an SS/PBCH block. In addition to the PCI, the SSB encodes an SSB index, which may be detected by the UE. The SSB may comprise one or more synchronization sequences, such as the Primary Synchronization Sequence (PSS) and the Secondary Synchronization Sequence (SSS).

The RS may correspond to a channel state information reference signal (CSI-RS), a tracking reference signal (TRS), a demodulation RS (DMRS), etc.

In one set of embodiments, the at least one of a configuration of L1/L2 based inter-cell mobility candidate cell comprises the configuration that the UE needs to operate accordingly when it performs L1/L2 inter-cell mobility (execution) to the L1/L2 based inter-cell mobility candidate cell, e.g., upon reception of the lower layer signaling indicating a L1/L2 based inter-cell mobility to that L1/L2 based inter-cell mobility candidate cell, which becomes the target cell and the current (new) PCell, or an SCell in a serving frequency. Even though that is the primary purpose of the target candidate L1/L2 inter-cell mobility cell, particular embodiments include an additional use, which is to indicate to the UE what are the relevant cell(s) and SSs/RSs of the relevant cell for performing CSI measurements even before accessing that target candidate cell. The UE operating accordingly may mean that the UE applies the configuration of L1/L2 based inter-cell mobility candidate cell, or switches to it, or activates it upon reception from the network of a L1/L2 inter-cell mobility command, wherein the L1/L2 inter-cell mobility command comprises the lower layer signaling (e.g., MAC CE or downlink control indicator) indicating to the UE the execution of L1/L2 inter-cell mobility to the L1/L2 inter-cell mobility candidate cell.

In one set of embodiments, the UE is configured with multiple target L1/L2 inter-cell mobility candidate cells, i.e., the UE receives multiple configurations, one per L1/L2 based inter-cell mobility candidate cell. If these are all from the same DU, the candidate DU generates and sends to the CU multiple configuration(s) of multiple L1/L2 based inter-cell mobility candidate cell(s), which the UE receives in an RRC Reconfiguration message.

Some embodiments include determining the frequency to measure. For example, in one set of embodiments, the UE performs at least one CSI measurement on at least one SS and/or at least one RS based on at least one frequency information of a SS and/or or a RS of the L1/L2 inter-cell mobility candidate cell.

The frequency information of the SS may comprise an absolute frequency value, such as an absolute radio-frequency channel number (ARFCN) value, used to indicate the frequency in which the SS is meant to be detected by the UE (i.e., where the UE assumes the SS is being transmitted). The ARFCN may be applicable for a downlink and/or uplink and/or bi-directional (TDD) global frequency raster in a radio access technology (RAT), such as New Radio (NR) or a 6G air interface.

When the SS corresponds to an SSB, or one of the signals comprising the SSB, such as a PSS and/or SSS and/or DMRS, the frequency information of the SS may correspond to an SSB frequency. The frequency information of the SS may also be referred to as a carrier frequency of the SS, or of the cell, e.g., when the SS defines a cell (like for a cell defining SSB).

The frequency information of the RS may comprise one or more frequency related information used to indicate the frequency in which the RS is meant to be detected by the UE (i.e., where the UE assumes the RS is being transmitted) and its bandwidth (if it is configurable).

The frequency information of the SS and/or CSI-RS may comprise one or more of the following. The frequency information may include an absolute frequency value (e.g., an ARFCN value) used as a reference, such as the Point A (or point A frequency), which may correspond to the lowest subcarrier of a pre-defined resource block, e.g., common resource block (RB) 0, that may be used as reference for multiple RS resources. That may be needed at least for CSI-RS.

The frequency information may include an offset to/from that absolute frequency value (e.g., an ARFCN value) used as a reference, such as an offset to Point A (or point A frequency).

The frequency information may include a subcarrier spacing for the RS and/or a bandwidth, e.g., indicated in number of physical resource blocks (PRBs).

For the SSB, the UE may know from its memory some frequency information depending on the SSB frequency, such as the position of resources within the PRBs, the bandwidth, the initial PRB, the center of the SSB, etc.

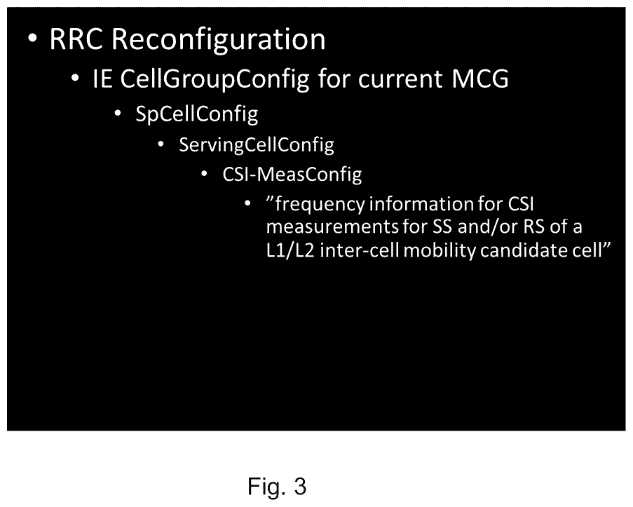

There are different ways the UE may obtain the at least one frequency information of a SS and/or or a RS of the L1/L2 inter-cell mobility candidate cell. In a set of embodiments, the UE obtains the at least one frequency information of a SS and/or or a RS by receiving a CSI measurement configuration in the RRC message, wherein the CSI measurement configuration is part of a serving cell configuration, e.g., within the IE CSI-MeasConfig transmitted in a series of nested IEs within the ServingCellConfig for the SpCell and/or for an SCell, as illustrated in FIG. 3.

FIG. 3 illustrates an example of how a UE may receive a frequency information for CSI measurements for SS and/or RS of a L1/L2 inter-cell mobility candidate.

In some embodiments, the at least one frequency information of a SS and/or or a RS within the CSI measurement configuration in the RRC message, part of the serving cell configuration, may correspond to an identifier pointing to another IE and/or parameter in which the frequency for SS and/or CSI-RS are included. For example, the identifier may be a measurement object ID, which points to a measurement object configured with a measurement configuration, wherein the Measurement Object associated to the identifier includes the configuration of the at least one frequency information of a SS and/or RS.

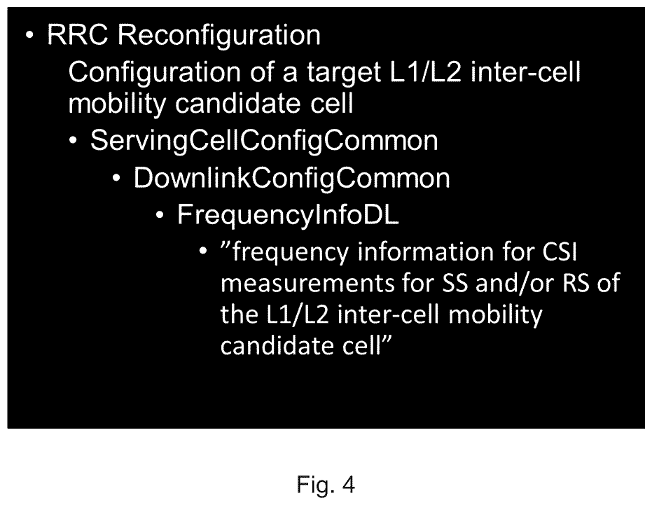

In a set of embodiments, the UE obtains the at least one frequency information of a SS and/or or a RS by receiving the configuration of a target L1/L2 inter-cell mobility candidate cell in the RRC message. The at least one frequency information of a SS and/or or a RS may correspond to one or more frequency information associated to the target L1/L2 inter-cell mobility candidate cell, such as the frequency of the cell, the absolute frequency of the cell to be used as reference (e.g., point A frequency). In some embodiments, that is obtained within the target L1/L2 inter-cell mobility candidate cell, e.g., as part of the cell-specific configuration (e.g., ServingCellConfigCommon) as illustrated in FIG. 4.

FIG. 4 illustrates another example of how a UE may receive a frequency information for CSI measurements for SS and/or RS of a L1/L2 inter-cell mobility candidate.

In one set of embodiments, the UE performs CSI measurements on at least one SS and/or or RS of the target L1/L2 inter-cell mobility candidate cell based on one or more configurations/parameters/fields of the at least one configuration of a target L1/L2 inter-cell mobility candidate cell, wherein the one or more configurations/parameters/fields comprises: beam configuration(s), wherein a beam configuration comprises a beam identifier; SS index(es) and/or one or more RS identifier(s); TCI state configuration(s), wherein a TCI state configuration comprises an associated RS identifier and/or an SS index; QCL configuration(s), wherein a QCL configuration comprises an associated RS identifier and/or an SS index; TCI state configuration(s), wherein a TCI state configuration comprises an associated QCL configuration with an associated RS identifier and/or an SS index; CSI measurement configuration, comprising one or more CSI resource configuration(s), wherein a CSI resource configuration indicates at least one SS index and/or at least one RS identifier to be measured when the UE operates in the target L1/L2 inter-cell mobility candidate cell; and cell identifier(s) (e.g. physical cell identity).

Some embodiments include determining the SS/RS to measure. For example, in one set of embodiments, the one or more configurations/parameters/fields of the at least one configuration of a target L1/L2 inter-cell mobility candidate cell are part of a dedicated (or UE-specific) configuration, because parameters may be adjusted for the specific UE, according to the UE capabilities/radio capabilities. The UE determines which SSs (e.g., SSBs) and RSs (e.g., CSI-RS resources) to perform CSI measurements for CSI reporting within the dedicated configuration.

In one set of embodiments, the UE performs CSI measurements on the SSs (e.g., SSBs) and/or RSs (e.g., CSI-RS resources) whose indexes or identifiers are configured as QCL source(s) in the TCI state configuration(s) within the dedicated configuration for the target candidate cell. The dedicated configuration for the target candidate cell for L1/L2 inter-cell mobility comprises a list of TCI state configurations. Each TCI state configuration has an associated QCL configuration comprising an SS index and/or RS index/identifier.

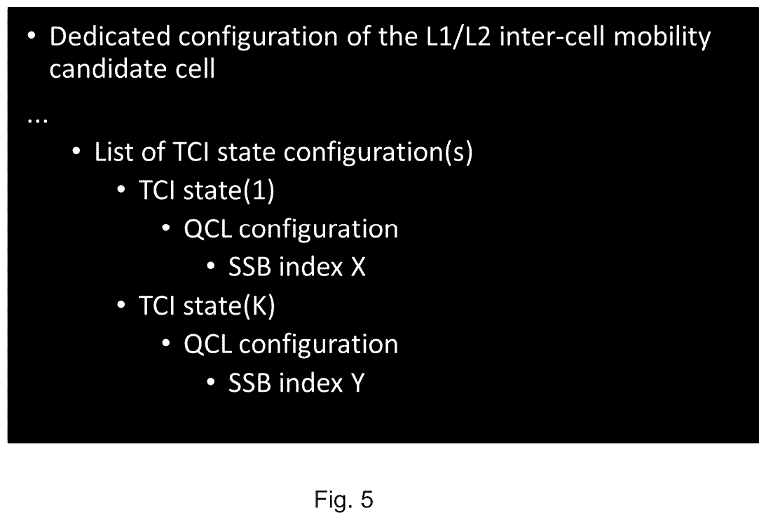

In the example illustrated in FIG. 5, the UE receives the dedicated configuration of the L1/L2 inter-cell mobility candidate cell (e.g., IE ServingCellConfig or equivalent) within the configuration of a target L1/L2 inter-cell mobility candidate cell comprising the list of TCI states: TCI state (1) and TCI state (K). In TCI State(1) the QCL configuration has an SSB index X, and in TCI State(K) the QCL configuration has an SSB index Y. Thus, the UE performs CSI measurements on SSBs associated to SSB index X and SSB index Y of that L1/L2 inter-cell mobility candidate cell, and reports CSI derived based on SSB index X and SSB index Y to be reported on one of its serving cells (e.g., PCell, SCell, PSCell) to assist the network in L1/L2 inter-cell mobility, as illustrated in FIG. 5.

FIG. 5 illustrates an example of how the UE may receive indications of which SSs and/or RSs for CSI measurements of a L1/L2 inter-cell mobility candidate.

In one set of embodiments, the UE performs CSI measurements on the SSs (e.g., SSBs) whose indexes or identifiers are configured as QCL source(s) in the TCI state configuration(s) within the dedicated configuration for the target candidate cell, but not on the RSs (e.g., CSI-RS resources). Such a solution enables the candidate DU to generate a configuration of a target L1/L2 inter-cell mobility candidate cell that contain TCI states whose QCL sources are associated to both CSI-RSs and SSBs (not necessarily in the same TCI state and QCL source), but for the purpose of indicating to the UE what to measure CSI for and assisting L1/L2 inter-cell mobility measurements, only SSs are considered, because these are transmitted periodically and are cell specific/always transmitted (not only when a UE is configured with).

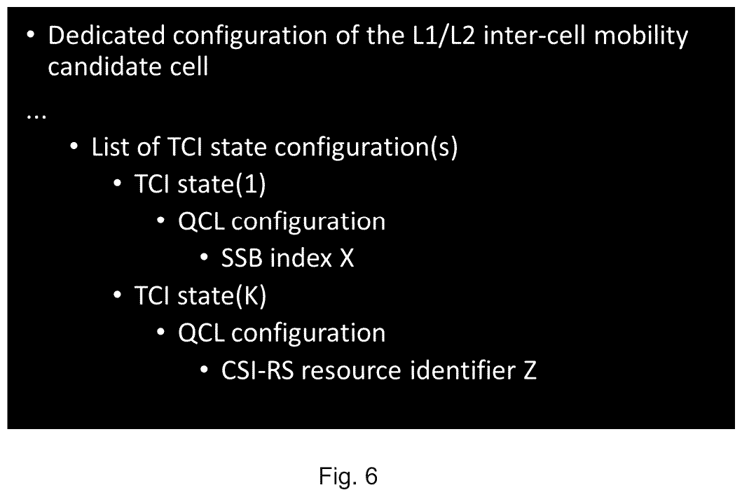

For example, in TCI State(1) the QCL configuration has an SSB index X, and in TCI State(K) the QCL configuration has a CSI-RS resource identifier Z. Thus, the UE performs CSI measurements only on the SSB associated to SSB index X of that L1/L2 inter-cell mobility candidate cell, and reports CSI derived based on SSB index X to be reported on one of its serving cells (e.g., PCell, SCell, PSCell) to assist the network in L1/L2 inter-cell mobility, as illustrated in FIG. 6.

FIG. 6 illustrates another example of how a UE may receive indications of which SSs and/or RSs for CSI measurements of a L1/L2 inter-cell mobility candidate.

In one set of embodiments, the UE performs CSI measurements on the SSs (e.g., SSBs) and/or RSs (e.g., CSI-RS resources) whose indexes or identifiers are configured as QCL source(s) in the TCI state configuration(s) within the dedicated configuration for the target candidate cell, and based on QCL type they are associated to. For example, the UE performs CSI measurements on the SSs and/or RSs configured as QCL source type D, or a corresponding QCL type related to beamforming properties/spatial receiver properties.

In one set of embodiments, the UE performs CSI measurements on the SSs (e.g., SSBs) and/or RSs (e.g., CSI-RS resources) whose indexes or identifiers are configured as QCL source(s) in the TCI state configuration(s) within the dedicated configuration for the target candidate cell, and based on the CSI Resource Configuration within the dedicated configuration.

In one set of embodiments, the UE performs CSI measurements on the SSs (e.g., SSBs) and/or RSs (e.g., CSI-RS resources) that are configured as periodic resources. For example, the target candidate cell configuration may have TCI states whose QCL configurations comprise CSI-RSs. However, the UE performs CSI measurements on the CSI-RS configured as periodic resources. The UE may determine that by identifying the CSI-RS resource identifier in the QCL source configuration and checking in the CSI Resource configuration associated whether that is periodic.

In one set of embodiments, the UE performs CSI measurements on the SSs (e.g., SSBs) and/or RSs (e.g., CSI-RS resources) that are explicitly indicated to be measured for the purpose of assisting L1/L2 inter-cell mobility. The indication may be set by the candidate DU to indicate which out of the TCI states are to be considered as possible target TCI states in L1/L2 inter-cell mobility.

In one set of embodiments, the one or more configurations/parameters/fields may be received within the IE ServingCellConfig (or equivalent IE) comprising the frequency configuration for downlink and uplink (including Bandwidth parts), L1 control channels (such as PDCCH, CORESET(s)), PUCCH) and L1 data channels (such as PDSCH, PUSCH), beam configuration(s), TCI state configuration, QCL configurations, and further parameters as defined in the IE ServingCellConfig defined in TS 38.331.

In one set of embodiments, the UE performs CSI measurements on the SSs (e.g., SSBs) and/or RSs (e.g., CSI-RS resources) whose beam(s) are configured as “candidate beams” of the target L1/L2 inter-cell mobility candidate cell.

Some embodiments include determining the cell(s) to measure. For example, in a set of embodiments, the UE performs CSI measurements for transmitting a CSI report to the network on at least one cell whose cell identifier (e.g., PCI) is indicated in the configuration of a target L1/L2 inter-cell mobility candidate cell.

In one set of embodiments, the cell identifier (e.g., PCI) of the target L1/L2 inter-cell mobility candidate cell is configured in a common (or cell-specific) configuration, because parameters are common to various UEs in that cell. The UE determines which cell to measure CSI, on the cell's SSs (e.g., SSBs) and RSs (e.g., CSI-RS resources) for CSI reporting, within the common (or cell-specific) configuration.

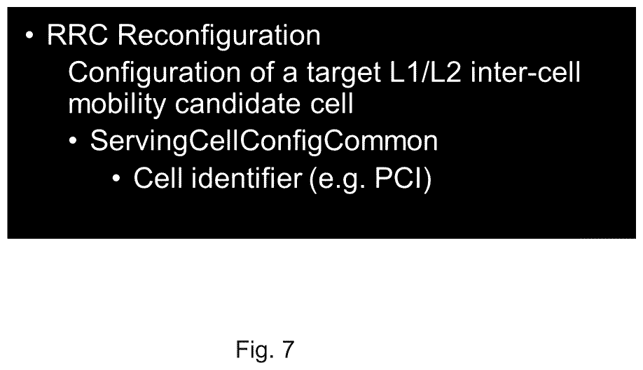

In one set of embodiments, the UE performs CSI measurements on the cell whose identifier, e.g., PCI, is configured within the common/cell-specific configuration for the target candidate cell. The common configuration for the target candidate cell for L1/L2 inter-cell mobility comprises the PCI (field physCellId, IE PhysCellId). For example, the cell identifier may be indicated in the Serving Cell Configuration Common (e.g., IE ServingCellConfigCommon), which is part of the configuration of a target L1/L2 inter-cell mobility candidate cell. An example is illustrated in FIG. 7.

FIG. 7 illustrates an example of how a UE may receive indications of which cells to measure for CSI measurements i.e., which L1/L2 inter-cell mobility candidate(s)/PCI of the candidates.

In one set of embodiments, the UE performs CSI measurements on the cell whose identifier, e.g., PCI, is configured within the common/cell-specific configuration for the target candidate cell, wherein the target candidate cell is a candidate to be a primary cell (e.g., PCell, or PSCell) and/or special cell (SpCell, as defined in TS 38.331). This further limits the number of cell measurements for CSI reporting the UE is required to perform to assist L1/L2 inter-cell mobility (which means saving more UE power and only reporting relevant measurements). In one option, the UE is indicated which cells are to be measured, e.g., the UE may be indicated to only measure the primary cells, and the PCI is still obtained in the same manner for the cells for which the UE needs to perform CSI measurements.

In one set of embodiments, the UE performs CSI measurements on the cell whose identifier, e.g., PCI, is configured within the common/cell-specific configuration for the target candidate cell, wherein the target candidate cell is a candidate in the same frequency as the primary cell (e.g., PCell, or PSCell) and/or special cell (SpCell, as defined in TS 38.331).

In one set of embodiments, the UE performs CSI measurements on the cell whose identifier, e.g., PCI, is configured within the common/cell-specific configuration for the target candidate cell, wherein the target candidate cell is a candidate in the same frequency as a serving cell (e.g., PCell, PSCell, SCell of the master cell group, SCell of the secondary cell group).

In one set of embodiments, even if the UE is configured with multiple target L1/L2 inter-cell mobility candidate cells, the UE performs CSI measurements on the cell(s) whose identifier, e.g., PCI, is explicitly indicated within a common/cell-specific configuration received within an RRC message. This is the case when multiple target L1/L2 inter-cell mobility candidate cells are configured at the UE, but the network indicates to the UE to perform CSI measurements only to a subset of the candidate cells based, e.g., on whether all the cells are within the same RAN notification area (RNA) or any form of group determined by the network.

Some embodiments include CSI reporting and reporting configuration. In a set of embodiments, the UE transmits at least one CSI report comprising information based on the CSI measurements on the at least one SS and/or or a RS of a target candidate cell, wherein the UE determines the cell, SS and/or RS based on one of the previous sets of embodiments, wherein the CSI report is transmitted based one or more reporting configuration(s) comprising one or more reporting criteria.

In a set of embodiments, the UE is configured with an association between i) one or more CSI resource(s), such as the SSs and/or RS of the L1/L2 inter-cell mobility candidate cell (associated to a PCI and an SSB frequency and/or an RS frequency), determined according to one or more of the previous sets of embodiments; and ii) a reporting configuration.

In some embodiments, the association is configured by a reporting configuration (e.g., IE CSI-ReportConfig) comprising a configuration identifier for a L1/L2 inter-cell mobility candidate.

In one option, the serving DU receives from the CU a configuration identifier associated with a configuration of a L1/L2 inter-cell mobility candidate cell, e.g., in a UE CONTEXT MODIFICATION REQUEST from the CU to the serving DU indicating to the serving DU that L1/L2 inter-cell mobility is to be configured. The serving DU includes the configuration identifier in the Reporting Configuration (CSI-ReportConfig), so that the UE understands that a given Reporting Configuration is for resources to be determined based on the configuration of a L1/L2 inter-cell mobility candidate cell.

For example, the CU requests candidate DU(s) to configure L1/L2 inter-cell mobility candidate(s) cell A and cell B. The CU receives CellConfig(A) and CellConfig(B), and associates each to a configuration identifier, e.g. CellConfig(A): configId=5; CellConfig(B): configId=7. The CU indicates to the serving DU at least the configuration identifiers configId=5 and configId=7. The serving DU generates a Reporting Configuration based on configId=5 and configId=7. When the UE receives the Reporting Configuration including, e.g., configId=7, the UE determines the SSs and/or RSs and/or PCI and/or frequency information to perform CSI measurements based on the cell configuration associated to that same configuration Id i.e., cell B in this example. In that case, for example, the serving DU may not need to understand the configuration of a L1/L2 inter-cell mobility candidate cell, which actually includes the SS indexes and/or RS identifiers and PCI the UE measures.

CellConfig(x) refers to the configuration associated to a target candidate cell x, and may be an IE comprising at least the parameters for the target candidate cell, but may also comprise associated parameters. For example, the CellConfig(x) may correspond to a cell group configuration (e.g., an MCG or SCG configuration), e.g., like a CellGroupConfig IE, including the target candidate cell as part of a possible serving cell within that group.

In a set of embodiments, the reporting criteria for reporting the CSI comprises one or more of: periodic, aperiodic, semi-persistent, for which the UE transmits the CSI report.

In a set of embodiments, the reporting configuration comprises one or more of configuration of physical uplink channel such as physical uplink control channel (PUCCH) and/or physical uplink shared channel (PUSCH) where the UE transmits a CSI report and configuration of one or more reporting quantity(ies) to be measured and included in the CSI report, such as RI, CQI, SSBRI, CRI, L1-RSRP, L1-RSRQ, L1-SINR based on SSB(s) and/or CSI-RS resource(s) of a L1/L2 inter-cell mobility candidate cell.

In one set of embodiments, the one of more reporting configuration(s) are configured as part of a serving cell configuration, e.g., current PCell configuration (not a target candidate configuration). In other words, SSs, RSs and cells are determined based on the configuration of the configuration of a target L1/L2 inter-cell mobility candidate cell, while the one of more reporting criteria are configured as part of the serving cell configuration. This is because the reporting criteria is related to how the UE transmit the CSI report to the serving DU, while the resource the UE measures is of a target L1/L2 inter-cell mobility candidate cell.

In some embodiments, the reporting configuration indicates to the UE that it is for CSI measurements to assist L1/L2 inter-cell mobility (or to one or more L1/L2 inter-cell mobility candidate cells). Based on that, the UE determines the SSs and/or RSs and/or cells and/or frequencies based on as target L1/L2 inter-cell mobility candidate cell, according to one or more of the previous embodiments.

In some embodiments, the reporting configuration indicates to the UE that it is for CSI measurements to assist L1/L2 inter-cell mobility (or to one or more L1/L2 inter-cell mobility candidate cells) and, if one or more configuration(s) about SSs and/or RSs and/or cells and/or frequencies are absent, the UE determines that they are obtained based on a target L1/L2 inter-cell mobility candidate cell, according to one or more of the previous embodiments.

In some embodiments, the reporting configuration indicates to the UE the order in which the CSI measurement should be performed to assist L1/L2 inter-cell mobility. This means that the reporting configuration may indicate to the UE in which order the L1/L2 inter-cell mobility candidate cells should be measured. In one example, the reporting configuration may include a list with configId=5 first in the list and configId=7 second in the list. This means that the UE should measures first the Cell A and after the Cell B. Alternatively the reporting configuration may explicitly indicate in which order the cells should be measured, e.g., providing a list with Cell A in the first position of the list and Cell B in the second position.

In some embodiments, the reporting configuration may indicate to the UE to report CSI report for the configured target L1/L2 inter-cell mobility candidate cells regardless on whether the UE has successfully performed CSI measurement on a target L1/L2 inter-cell mobility candidate cell. In this case, if the UE was not able to perform any CSI measurement on a target L1/L2 inter-cell mobility candidate cell, then the UE sends to the network an empty CSI report.

In a set of embodiments, the UE receives a message (e.g., RRCReconfiguration) indicating the removal of a target candidate cell for L1/L2 inter-cell mobility, for which the UE has been performing measurements based on the configuration of the target L1/L2 inter-cell mobility candidate, e.g., according to any of the methods described herein. As that cell is removed, the configuration of the target L1/L2 inter-cell mobility candidate may be deleted and the UE may stop performing measurements performed according to one of the methods.

Some embodiments include information received in a RRC message from a source. Particular embodiments and examples refer to the UE receiving an RRC message from a network node comprising at least one configuration of a target L1/L2 inter-cell mobility candidate cell. If the UE is configured with multiple L1/L2 inter-cell mobility candidate cells, the UE receives multiple configurations of a target L1/L2 inter-cell mobility candidate cell.

Each of these configurations may be modeled as an “RRC container”, which is either a message embedded in the RRC Reconfiguration the UE receives, or an RRC Information Element (IE)/field/parameter (or sets of parameters) for the UE's operation for L1/L2 inter-cell mobility execution.

The content and/or structure of this IE and/or embedded message which comprises the configuration of a L1/L2 based inter-cell mobility candidate cell may be referred to as an RRC model for the candidate configuration, or simply RRC model.

In one set of embodiments, the at least one of a L1/L2 based inter-cell mobility candidate cell comprises the configuration which the UE needs to operate accordingly when it performs (executes) L1/L2 inter-cell mobility to that L1/L2 based inter-cell mobility candidate cell, upon reception of the lower layer signaling indicating a L1/L2 based inter-cell mobility to that L1/L2 based inter-cell mobility candidate cell (which becomes the target cell and the current (new) PCell, or an SCell in a serving frequency).

In one set of embodiments, the UE may be configured with multiple candidates, so a candidate DU generates and sends to the CU multiple configuration(s), e.g., each per L1/L2 based inter-cell mobility candidate cell.

In one set of embodiments, the configuration of a L1/L2 based inter-cell mobility candidate cell comprises parameters of a serving cell (or multiple serving cells) comprising one or more of the groups of parameters within the IE SpCellConfig (or the IE SCellConfig, in the case of a Secondary Cell), such as any of the following.

In some embodiments, the configuration includes a cell index (e.g., encoding fewer bits than the cell identifier of the L1/L2 inter-cell mobility candidate cell). That may be a field ‘servCellIndex’ or ‘candidateCellIndex’ of IE ‘ServCellIndex’ or IE ‘CandidateCellIndex’. After this being configured, the index may be later referred, for example: i) in the lower layer signaling to indicate to the UE that this is the L1/L2 inter-cell mobility candidate cell the UE needs to move to in the L1/L2 inter-cell mobility procedure; ii) in an RRC message indicating some operation in that particular candidate cell.

In some embodiments, the configuration includes a cell configuration for the UE corresponding to the configuration of a L1/L2 based inter-cell mobility candidate cell, referred to as a dedicated configuration as parameters are possibly adjusted for that specific UE, according to the UE capabilities/radio capabilities. The configuration may comprise parameters defined in the IE ServingCellConfig such as the frequency configuration for downlink and uplink (including Bandwidth parts), L1 control channels (such as PDCCH, CORESET(s)), PUCCH) and L1 data channels (such as PDSCH, PUSCH) and further parameters as defined in the IE ServingCellConfig defined in TS 38.331.

In some embodiments, the configuration includes a cell referred to as common cell configuration, also referred to as cell-specific configuration, corresponding to the configuration of a L1/L2 based inter-cell mobility candidate cell in the IE ServingCellConfigCommon. That may be provided within the IE ReconfigurationWithSync or separately. This configuration contains, for example, the random access configuration for the UE to access the target candidate, if necessary.

This may include a radio link failure (RLF) configuration(s) such as values for timer T310, counter N310, counter N311, timer N311. It may include at least one UE identifier to identify the UE in the L1/L2 based inter-cell mobility candidate cell such as a cell radio network temporary identifier (C-RNTI).

In some embodiments, the UE may be configured with multiple L1/L2 inter-cell mobility candidate cells, so the candidate DU generates and sends to the CU, multiple sets of parameters of a serving cell, comprising one or more of the groups of parameters within multiple IE SpCellConfig(s). For example, the UE may receive a list of IEs SpCellConfig(s), one for each L1/L2 inter-cell mobility candidate.

In one set of embodiments, the configuration of a L1/L2 based inter-cell mobility candidate cell may be the SpCell configuration (e.g., PCell configuration) provided as part of a cell group configuration, which may further comprise one or more SCell configuration(s) and further cell group-specific configurations (cell group identity, physical layer configuration for the cell group, MAC layer configuration for the cell group, simultaneous TCI state configurations for the cell group, etc.).

In this case, the UE is configured with a cell group configuration per candidate. Thus, one alternative is the UE to receive one configuration per Cell Group candidate, wherein the configuration of a L1/L2 based inter-cell mobility candidate cell is the SpCell candidate configuration within that group. Then, the lower layer signaling indicates the UE to change to a configured cell group candidate, e.g., applying the cell group configuration for that candidate, e.g., from a MCG configuration A to an MCG configuration B.

When the UE is configured with multiple candidates, the candidate DU generates and sends to the CU multiple cell group configuration(s), each associated to each L1/L2 inter-cell mobility candidates, e.g., a list of CellGroupConfig IEs. The L1/L2 inter-cell mobility candidate may be in the same frequency as the current PCell, or in a different frequency.

In one set of embodiments, the L1/L2 inter-cell mobility candidate may be an SCell candidate.

Some examples of how the signaling may be implemented in RRC for the configuration of a L1/L2 based inter-cell mobility candidate cell are described as RRC models for L1/L2 based inter-cell mobility:

a) RRC Reconfiguration per candidate cell. In this case the UE receives multiple (a list of) RRC messages (i.e., RRCReconfiguration message) within a single RRCReconfiguration message. Each RRCReconfiguration message identify a configuration of a L1/L2 based inter-cell mobility candidate cell that is stored by the UE and is applied/used/activated when receiving the lower layer signaling for L1/L2 inter-cell mobility. This model enables the full flexibility, as in L3 reconfigurations, for the target node to modify/release/keep any parameter/field in the RRCReconfiguration message, such as measurement configuration, bearers, etc.

b) CellGroupConfig per candidate cell. With this model the UE receives within an RRCReconfiguration a list of CellGroupConfig IEs and each one of them identify a configuration of a L1/L2 based inter-cell mobility candidate cell. Each CellGroupConfig IE is stored at the UE and is applied/used/activated when receiving the lower layer signaling for L1/L2 inter-cell mobility. This model enables the target node to modify/release/keep any parameter/field that is part of a CellGroupConfig IE while the rest of the RRCReconfiguration message (that is where the CellGroupConfig IE is received by the UE) remain unchanged. This means that, e.g., measurement configuration, bearers, and security remain the same and are not changed by the target node.

c), d), and f) “K” SpCellConfig or “K” ServingCellConfigCommon, or both per cell. With this model the UE receives either “K” SpCellConfig per cell (option c), “K” ServingCellConfigCommon per cell (option e), or “K” SpCellConfig and “K” ServingCellConfigCommon per cell (option d) as a configuration of a L1/L2 based inter-cell mobility candidate cell. This solution provides only minimum flexibility for the target node because only cell-specific parameters (e.g., bandwidth parts, downlink, and uplink configurations) can be modified/released/kept.

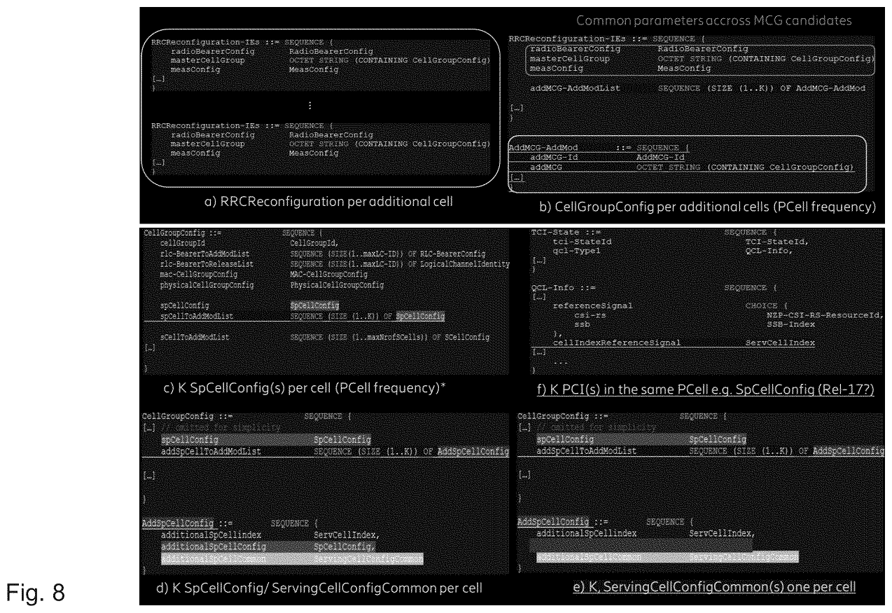

f) “K” PCI in the same PCell. With this model multiple PCIs are configured for the same TCI state configuration where each PCI identify a configuration of a L1/L2 based inter-cell mobility candidate cell. This approach provides no flexibility because all the parameters/fields used for configuring a configuration of a L1/L2 based inter-cell mobility candidate cell are fixed and only a change of PCI, scrambling Id, and C-RNTI is allowed to the target node. An example is illustrated in FIG. 8.

FIG. 8 illustrates common parameters across master cell group candidates.

Some embodiments include interaction between UE, candidate DU, serving DU and CU. For example, in a set of embodiments, upon receiving the configuration of a target L1/L2 inter-cell mobility candidate cell from the network, the UE measures (e.g., derives CSI) one or more of the configured SSs and/or RSs of the one or more L1/L2 inter-cell mobility candidate cell (there can be one or more), and, based on a reporting criteria (e.g., periodic, aperiodic, semi-persistent), the UE transmits a CSI report to the network. These RSs and/or SSs to be measured are referred (directly or indirectly) in a reporting configuration, indicating how the UE shall report CSI associated to these configured RSs. In one option, based on the report, the network decides to trigger L1/L2 inter-cell mobility for that UE, and transmits a lower layer signaling indicating the switching of the serving cell and/or beam (TCI state). If the network receives an “empty” CSI report for a target L1/L2 inter-cell mobility candidate cell, then the network may decide to release that target L1/L2 inter-cell mobility candidate cell from the UE.

In a set of embodiments, the configuration of a target L1/L2 inter-cell mobility candidate cell is generated by a candidate DU, which is the DU responsible for the L1/L2 inter-cell mobility candidate cell. Consequently, the candidate DU generates the information within the configuration of a target L1/L2 inter-cell mobility candidate cell, which is used by the UE for determining the cell and/or SSs and/or RSs and/or frequency to be measured for CSI reporting. The candidate DU also transmits the set of RSs and/or SSs to be measured by the UE.

The candidate DU may correspond to a serving DU, i.e., the DU responsible for the primary cell the UE is connected to (e.g., Special Cell (SpCell), Primary Cell (PCell), Primary Secondary Cell Group Cell (PSCell)) or is going to connect to. In that case, the Serving DU receives a message from the CU (e.g., UE Context Modification Request message over F1AP) including the request to configure the UE with L1/L2 inter-cell mobility and, in response, it generates the configuration of a target L1/L2 inter-cell mobility candidate cell in a response message transmitted to the CU (e.g., UE Context Modification Response message).

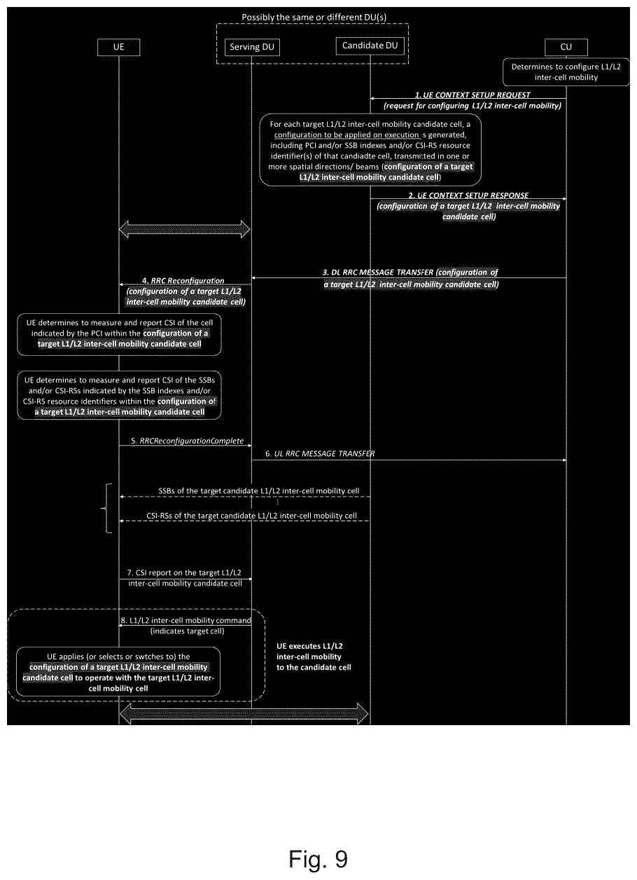

The candidate DU may correspond to a neighbor DU, i.e., the DU that is not responsible for the primary cell the UE is connected to. In that case, the neighbor DU receives a message from the CU (e.g., UE Context Setup Request message over F1AP) including the request to configure the UE with L1/L2 inter-cell mobility and, in response, it generates the configuration of a target L1/L2 inter-cell mobility candidate cell, and includes in a response message transmitted to the CU (e.g., UE Context Setup Response message), as illustrated in FIG. 9.

FIG. 9 is a flow diagram illustrating an example of a signaling flow when the candidate DU is a neighbor DU. The following steps use FIG. 9 as a reference for describing most of the steps, but the descriptions of the steps should not be limited to the figure. When sets of embodiments are described, they should not be limited to the case where the candidate DU is a neighbor DU, but also for the case where the candidate DU is a serving DU, unless stated otherwise.

At step 1, the CU determines to configure a UE, which is connected to the CU and is capable of L1/L2 inter-cell mobility, with at least one L1/L2 inter-cell mobility candidate (CU may optionally determine one or more candidate cells and the associated DU, which is the neighbor DU). The CU transmits a request to a neighbor DU for configuring L1/L2 inter-cell mobility, e.g., by transmitting a UE CONTEXT SETUP REQUEST message over F1AP, including an indication that this is for requesting the neighbor DU to configure at least one L1/L2 inter-cell mobility candidate cell. In response to the message, the neighbor DU generates the L1/L2 inter-cell mobility candidate cell configuration for a target candidate, including beam related configuration(s) to be primarily used when the UE operates in the target candidate after execution, and, according to the one or more embodiments, to be used by the UE to determine which frequencies and/or cells and/or SSBs and/or CSI-RSs to be measured for CSI reporting, to support L1/L2 inter-cell mobility decisions at the network. To be measured means the UE derives a CSI based on that configuration, e.g., SS-RSRP, L1 RSRP for an SSB or CSI-RS.

At step 2, the neighbor DU transmits to the CU a message (e.g., UE CONTEXT SETUP RESPONSE over F1AP, in the case the candidate DU is a neighbor DU) including the configuration(s) of each L1/L2 inter-cell mobility candidate cell the neighbor DU configures as candidates.

In a set of embodiments (between steps 2 and 3), the CU transmits a message to the serving DU (e.g., UE Context Modification Request) and receives a response (e.g., UE Context Modification Response) including at least a CSI reporting configuration (to be included in the RRC Reconfiguration to be provided to the UE) of one of the UE's configured serving cells (e.g., primary cell or secondary cell) for reporting CSI over the uplink channel of the cell in which the reporting configuration is included. The CSI reporting configuration is associated to a resource configuration of a L1/L2 inter-cell mobility target candidate, so that the UE determines to measure a resource of a L1/L2 inter-cell mobility candidate cell (e.g., an SSB-x of candidate cell A) and report CSI over an uplink (e.g., periodic or aperiodic CSI) of the serving cell in which the reporting configuration is configured (e.g., over its PUCCH and/or PUSCH, or any other uplink channel configured for that kind of CSI reporting). The CSI reporting configuration from the serving DU to be provided to the CU to then be included in the RRC Reconfiguration that the UE receives may comprise an association between i) one or more CSI resource(s), such as the SSs and/or RS of the L1/L2 inter-cell mobility candidate cell (associated to a PCI and an SSB frequency and/or an RS frequency), determined according to one or more of the previous sets of embodiments; and ii) a reporting configuration.

In some embodiments, the association is configured by a reporting configuration (e.g., IE CSI-ReportConfig) comprising a configuration identifier for a L1/L2 inter-cell mobility candidate. The serving DU includes the configuration identifier in the Reporting Configuration (CSI-ReportConfig), so that the UE understands that a given Reporting Configuration is for resources to be determined based on a configuration of a L1/L2 inter-cell mobility candidate cell. For example, the CU requests candidate DU(s) to configure L1/L2 inter-cell mobility candidate(s) cell A and cell B. The CU receives CellConfig(A) and CellConfig(B), and associates each to a configuration identifier, e.g., CellConfig(A): configId=5; CellConfig(B): configId=7. The CU indicates to the serving DU at least the configuration identifiers configId=5 and configId=7. The serving DU generates a Reporting Configuration based on configId=5 and configId=7. When the UE receives the Reporting Configuration including, e.g. configId=7, the UE determines the SSs and/or RSs and/or PCI and/or frequency information to perform CSI measurements based on the cell configuration associated to that same configuration Id, i.e., cell B in this example. In that case, for example, the serving DU may not need to understand the configuration of a L1/L2 inter-cell mobility candidate cell, which actually includes the SS indexes and/or RS identifiers and PCI the UE measures.

In a set of embodiments (between steps 2 and 3), the CU generates a CSI reporting configuration, including the resource configuration(s) from the neighbor DU. In some embodiments, the CSI measurement configuration, comprising reporting configuration for one of the UE's configured serving cell (e.g., for reporting CSI measurements on an uplink channel of one of the serving cells) is configured by the CU, and included in the RRC Reconfiguration received by the UE, wherein the CSI measurement configuration for reporting CSI of L1/L2 inter-cell mobility candidate cell(s) is configured outside the Cell Group Configuration (e.g., MCG configuration). In one embodiment, the CSI measurement configuration may be within the Measurement Configuration for configuring RRC measurements and RRC measurement reports, e.g., within the IE MeasConfig defined in TS 38.331.

At step 3, the CU transmits a message (e.g., DL RRC MESSAGE TRANSFER over F1AP) to the serving DU including an RRC Reconfiguration message to the UE that includes per L1/L2 inter-cell mobility candidate cell.

As described in various sets of embodiments in Step 2, and in the previous parts of the text, the CU may transmit that message to the serving DU after having performed another procedure for obtaining a configuration from the serving DU to be included in the RRC Reconfiguration that is received by the UE, configuring the UE with the resource configurations per L1/L2 inter-cell mobility candidate cells, and associated CSI reporting configuration(s).

At step 4, the UE receives the RRC Reconfiguration message (e.g., RRCReconfiguration) including at least one configuration of a L1/L2 inter-cell mobility candidate cell, based on which the UE determines which SSBs and/or CSI-RSs are to be measured and reported in a CSI report.

Upon reception, the UE applies the RRC Reconfiguration message.

At step 5, after having received and applied the RRC Reconfiguration, the UE transmits the RRC Reconfiguration Complete message. In some embodiments, that message is transmitted when the UE verifies that at least the CSI resource configuration per L1/L2 inter-cell mobility candidate cell is compliant, e.g., measurements configured do not exceed the UE capabilities.

At step 6, the serving DU receives the RRC Reconfiguration Complete and transmits to the CU (e.g., in a UL RRC MESSAGE TRANSFER over F1AP).

In one set of embodiments, the CU receives from the serving DU the message indicating that the UE has received the at least one configuration(s) L1/L2 inter-cell mobility candidate cells as configured by the neighbor DU, which indicates that the UE has determined which SSBs and/or CSI-RS resources and/or frequencies and/or cells are to be measured to CSI reporting, to assist L1/L2 inter-cell mobility. In response, the CU transmits a message to the neighbor DU to indicate that. The neighbor DU, in response, may use the indication to start transmitting the required SSs and/or CSI-RSs for the candidate cells the UE is meant to measure for CSI reporting.

Some embodiments include involvement of the serving DU in configuring the CSI resource configuration per L1/L2 inter-cell mobility candidate(s) from neighbor DU. For example, some previous embodiments described involving the serving DU in the process of generating the CSI Reporting Configuration (CSI-ReportConfig) to be provided to the UE, associated to the SSs and/or RSs and/or cells and/or frequency(ies) the UE determines for measuring CSI on, based on the configuration of a L1/L2 inter-cell mobility candidate cell.

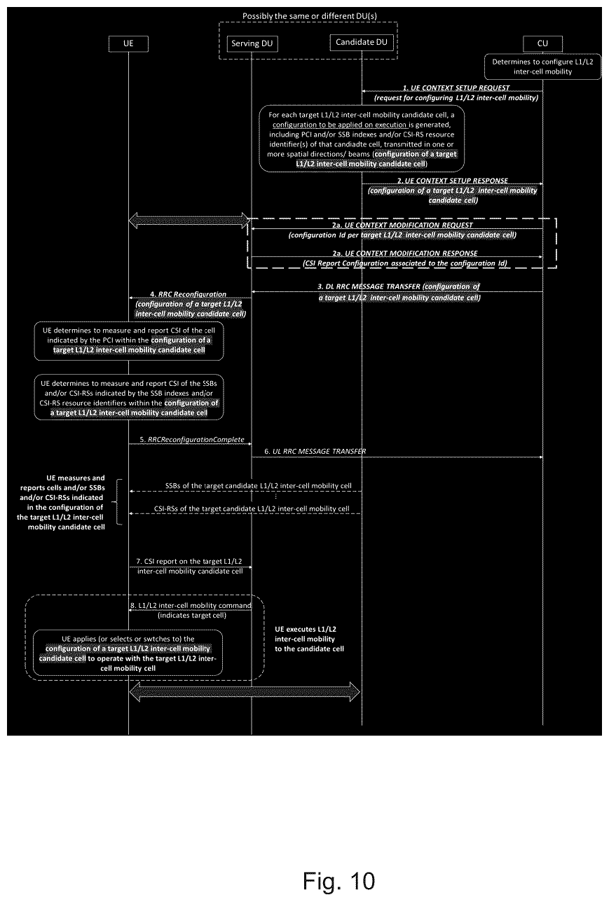

FIG. 10 illustrates an updated version of the signaling flow where these additional steps between the CU and the serving DU are shown.

FIG. 10 is a flow diagram illustrating an example of a signaling flow showing the procedure between a serving DU in configuring the mapping between CSI report configuration and each L1/L2 inter-cell mobility candidate(s) from neighbor DU, so the UE knows what CSI report configuration is associated to SSs and/or RSs and/or cells to be measured CSI and reported. In some embodiments, the serving DU may provide to the CU, to be included in the RRC Reconfiguration which goes to the UE (as shown in step 2a), part of the configuration necessary for the UE to perform the measurements, such as the reporting configuration comprising at least the frequency information and/or reporting configuration in general. However, the actual resources to be measured, such as RS indexes and/or SS indexes and/or cells is determined based on the L1/L2 inter-cell mobility target candidate cell configuration. Thus, according to the method the UE still performs the measurements based on the target candidate configuration for L1/L2 inter-cell mobility, as generated by the candidate DU, but also uses measurements from the serving DU.

In some embodiments, the candidate DU is the serving DU. For example, the candidate DU may correspond to a serving DU, i.e., the DU responsible for the primary cell the UE is connected to (e.g., Special Cell (SpCell), Primary Cell (PCell), Primary Secondary Cell Group Cell (PSCell)) or is going to connect to. In that case, the serving DU receives a message from the CU (e.g., UE Context Modification Request message over F1AP) including the request to configure the UE with L1/L2 inter-cell mobility and, in response, it generates the configuration of the L1/L2 inter-cell mobility candidate cell for each candidate, including information the UE uses to determine the SSs and RSs to be measured for CSI reporting.

The serving DU includes the configuration of the L1/L2 inter-cell mobility candidate cell for each candidate, also with a CSI reporting configuration associated to the configuration of the L1/L2 inter-cell mobility candidate cell, e.g., via the configuration identifier, in a response message transmitted to the CU (e.g., UE Context Modification Response message).

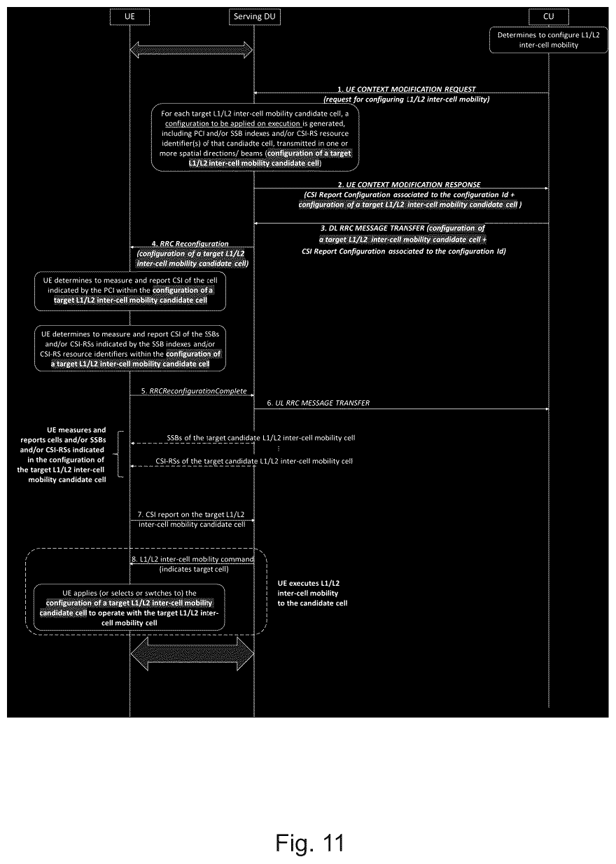

FIG. 11 is a flow diagram illustrating an example of a signaling flow when the candidate DU is a serving DU. At step 1, the CU determines to configure a UE, which is connected to the CU and is capable of L1/L2 inter-cell mobility, with at least one L1/L2 inter-cell mobility candidate (CU may optionally determine one or more candidate cells in the serving DU). The CU transmits a request to a serving DU for configuring L1/L2 inter-cell mobility by transmitting a UE CONTEXT MODIFICATION REQUEST message over F1AP, including an indication that this is for requesting the serving DU to configure at least one L1/L2 inter-cell mobility candidate cell.

In response to the message, the serving DU generates per L1/L2 inter-cell mobility candidate cell, the CSI reporting configuration for L1/L2 inter-cell mobility candidate cell, to support L1/L2 inter-cell mobility decisions at the network. To be measured means the UE derives a CSI based on that configuration, e.g. SS-RSRP, L1 RSRP for an SSB or CSI-RS.

At step 2, the serving DU transmits to the CU a UE CONTEXT MODIFICATION RESPONSE (over F1AP) including the configuration of the L1/L2 inter-cell mobility candidate cell the serving DU configures as candidates, and the CSI reporting configuration associated to the candidate cell, so the UE knows the configuration of the serving cell in which it needs to report CSI, and, based on the configuration of the L1/L2 inter-cell mobility candidate cell determine the SSs (e.g., SSBs) and/or RSs (CSI-RSs) and/or frequency(ies) and cells on which it needs to measure CSI on.

In a set of embodiments, the UE CONTEXT MODIFICATION RESPONSE may also include at least a CSI reporting configuration (to be included in the RRC Reconfiguration to be provided to the UE) of one of the UE's configured serving cells (e.g., primary cell or secondary cell) for reporting CSI over the uplink channel of the cell in which the reporting configuration is included. The CSI reporting configuration is associated to a configuration of the L1/L2 inter-cell mobility target candidate, so that the UE determines to measure a resource of a L1/L2 inter-cell mobility candidate cell (e.g., an SSB-x of candidate cell A) and report CSI over an uplink (e.g., periodic or aperiodic CSI) of the serving cell in which the reporting configuration is configured (e.g., over its PUCCH and/or PUSCH, or any other uplink channel configured for that kind of CSI reporting).

At step 3, the CU transmits a message (e.g., DL RRC MESSAGE TRANSFER over F1AP) to the serving DU including an RRC Reconfiguration message to the UE that includes the configuration of a L1/L2 inter-cell mobility candidate cell, and the CSI report configuration including the mapping to the associated candidate cell.

At step 4, the UE receives the RRC Reconfiguration message (e.g., RRCReconfiguration) including per L1/L2 inter-cell mobility candidate cell and determines the RSs and/or SSs to be measured (and/or cells and/or frequencies) and reported by the UE for CSI (also referred to herein as CSI resource configuration(s)). Within the RRC Reconfiguration message, in IE(s), fields and/or parameters, the UE may receive the configuration of each L1/L2 inter-cell mobility candidate cell to be applied (or switched to) upon L1/L2 inter-cell mobility execution, i.e., upon reception of a lower layer signaling (like a MAC CE or DCI indicating a L1/L2 inter-cell mobility candidate cell and/or TCI state of a L1/L2 inter-cell mobility candidate cell).

The sets of embodiments described in Step 4 with respect to FIG. 9 are also valid when the candidate DU is the serving DU. Upon reception the UE applies the RRC Reconfiguration message.

Step 3 contains various sets of embodiments disclosing different alternatives, concerning whether the IEs, fields and/or parameters included in the RRC Reconfiguration received by the UE are generated by the CU and/or by the serving DU, including the CSI reporting configuration per L1/L2 inter-cell mobility candidates from the serving DU.

At step 5, after having received and applied the RRC Reconfiguration, the UE transmits the RRC Reconfiguration Complete message. In some embodiments, the message is transmitted when the UE verifies that at least the CSI reporting configuration per L1/L2 inter-cell mobility candidate cell is compliant, e.g., measurements configured do not exceed the UE capabilities.

At step 6, the serving DU receives the RRC Reconfiguration Complete and transmits to the CU (e.g., in a UL RRC MESSAGE TRANSFER over F1AP).

In one set of embodiments, the CU receives from the serving DU the message indicating that the UE has received the configuration of each L1/L2 inter-cell mobility candidate cells as configured by the serving DU acting as candidate DU, and the associated CSI report configuration (e.g., including the mapping). In response, the CU transmits a message to the serving DU to indicate that. The serving DU, in response, may use that indication to start transmitting the configured resources per L1/L2 inter-cell mobility candidate cell. Another alternative is that the serving DU, upon having received the RRC Reconfiguration Complete message, starts transmitting the configured resources per L1/L2 inter-cell mobility candidate cell.

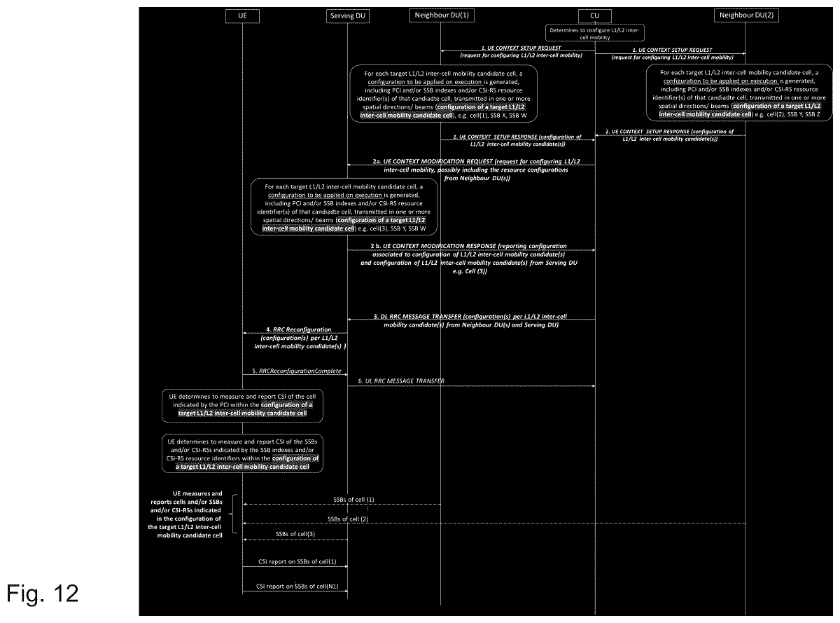

In some embodiments, candidate DU(s) are the serving DU and one or more neighbor DU(s). An example is illustrated in FIG. 12.

FIG. 12 is a flow diagram illustrating an example of a signaling flow for multiple candidate DU(s), with at least the serving DU and one or more neighbor DU(s). At step 1, the CU determines to configure a UE, which is connected to the CU and is capable of L1/L2 inter-cell mobility, with at least one L1/L2 inter-cell mobility candidate of the neighbor DU (1) and the neighbor DU(2), and transmits to each of these DUs a UE CONTEXT SETUP REQUEST message over F1AP, including an indication that this is for requesting the neighbor DU to configure at least one L1/L2 inter-cell mobility candidate cell. In response to the message, each of the requested neighbor DUs generates per L1/L2 inter-cell mobility candidate cell.

At step 2, each of the neighbor DUs transmit to the CU a UE CONTEXT SETUP RESPONSE message over F1AP, including the configuration of the set of RSs and/or SSs to be measured and reported by the UE for CSI, per L1/L2 inter-cell mobility candidate cell each neighbor DU configures as candidates.

At step 2a, the CU determines to configure a UE, which is connected to it and is capable of L1/L2 inter-cell mobility, with at least one L1/L2 inter-cell mobility candidate cell from the serving DU. The CU transmits a request to a serving DU for configuring L1/L2 inter-cell mobility by transmitting a UE CONTEXT MODIFICATION REQUEST message over F1AP, including an indication that this is for requesting the serving DU to configure at least one L1/L2 inter-cell mobility candidate cell.

In a set of embodiments, the UE CONTEXT MODIFICATION REQUEST message also includes one of more indications of configuration identifiers associated to one of more L1/L2 inter-cell mobility candidate cell(s), generated by neighbor DU(s).

In a set of embodiments, if the CU determines to configure the UE with L1/L2 inter-cell mobility candidate cells from the serving DU and from at least one neighbor DU, the CU first requests the configurations from the neighbor DUs, and obtains the responses of the neighbor DU(s), to only after send the request to the serving DU. This is done in such an order to enable the CU to send the information about the L1/L2 inter-cell mobility candidate cells of the neighbor DU(s) and the request for the serving DU to configure L1/L2 inter-cell mobility candidates in the same message, e.g., in the UE CONTEXT MODIFICATION REQUEST.

Thus, the serving DU is able to generate the mapping between the configuration of a L1/L2 inter-cell mobility candidate and a reporting configuration of one of the UE's serving cell(s) (wherein one of the UE's serving cells is of the serving DU).

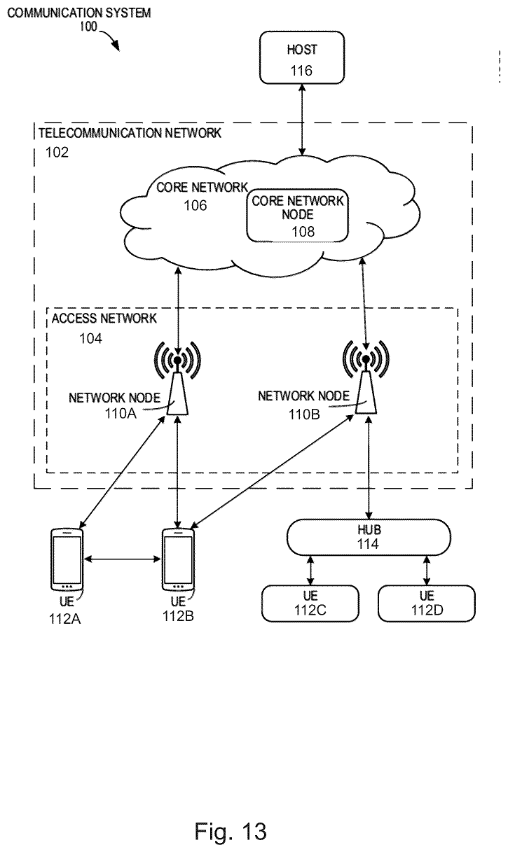

FIG. 13 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108.

The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

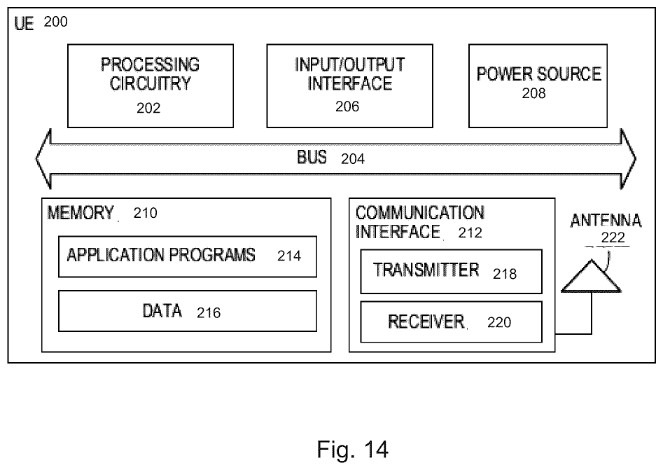

FIG. 14 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

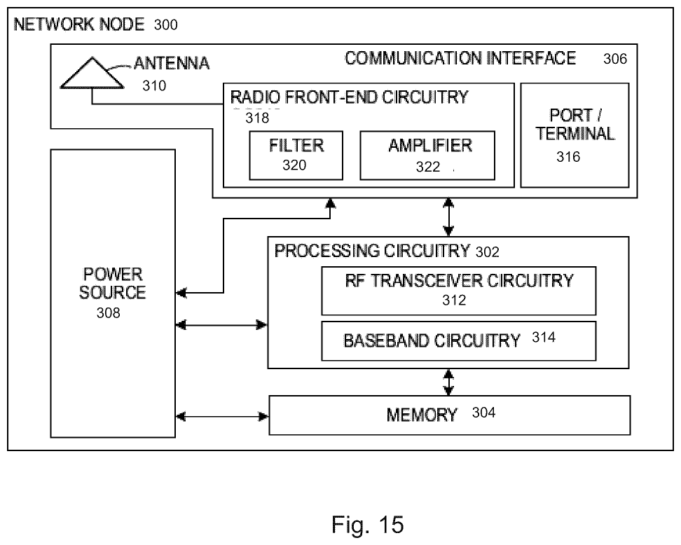

FIG. 15 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 15 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

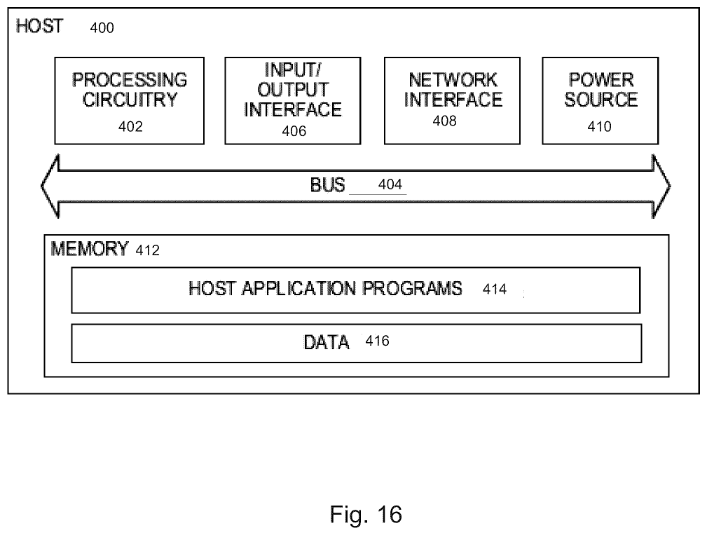

FIG. 16 is a block diagram of a host 400, which may be an embodiment of the host 116 of FIG. 13, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

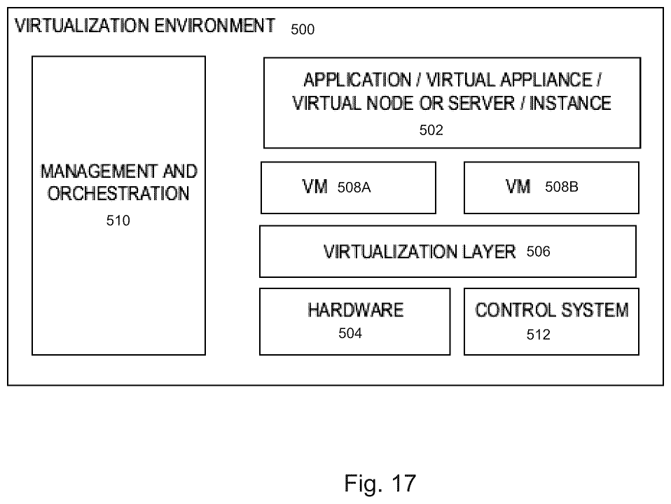

FIG. 17 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

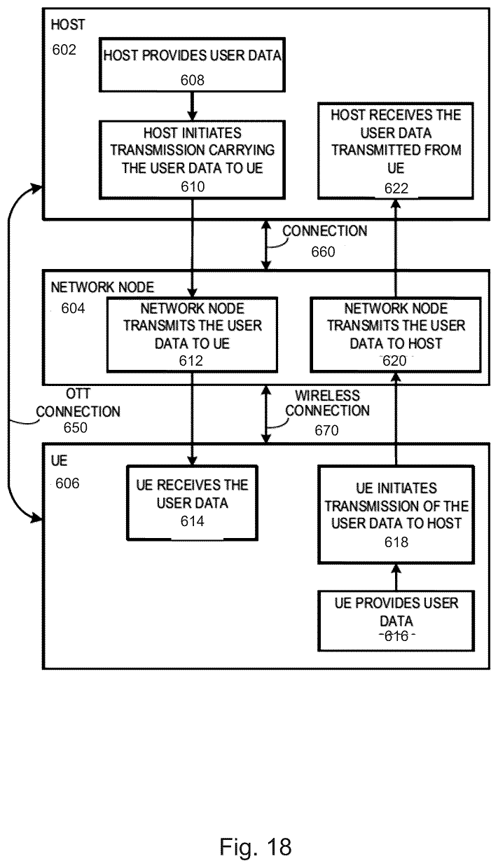

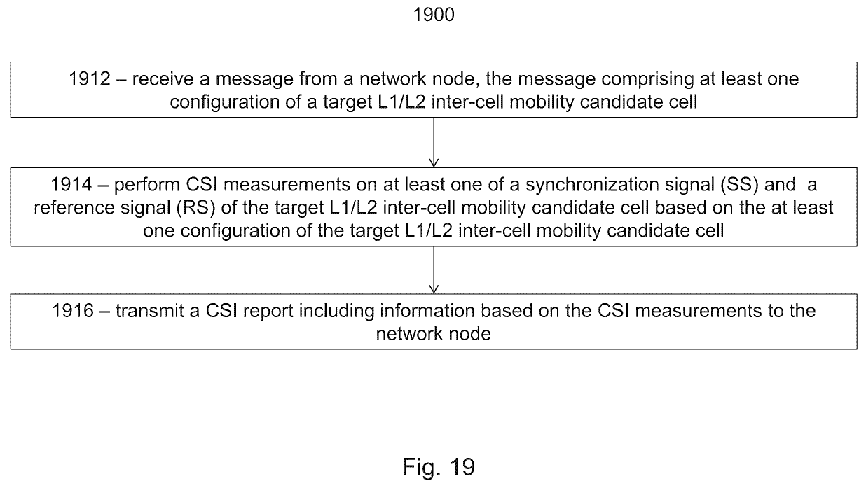

FIG. 18 shows a communication diagram of a host 602 communicating via a network node 604 with a UE 606 over a partially wireless connection in accordance with some embodiments. Example implementations, in accordance with various embodiments, of the UE (such as a UE 112a of FIG. 13 and/or UE 200 of FIG. 14), network node (such as network node 110a of FIG. 13 and/or network node 300 of FIG. 15), and host (such as host 116 of FIG. 13 and/or host 400 of FIG. 16) discussed in the preceding paragraphs will now be described with reference to FIG. 18.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 13) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606.

The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

FIG. 19 is a flowchart illustrating an example method in a wireless device, according to certain embodiments. In particular embodiments, one or more steps of FIG. 19 may be performed by UE 200 described with respect to FIG. 14. The wireless device is operable to perform CSI measurements for L1/L2 inter-cell mobility.

The method begins at step 1912, where the wireless device (e.g., UE 200) receives a message from a network node (e.g., network node 300). The message comprises at least one configuration of a target L1/L2 inter-cell mobility candidate cell.

In particular embodiments, the configuration of the target L1/L2 inter-cell mobility candidate cell comprises a configuration the wireless device uses in a target cell after L1/L2 inter-cell mobility execution. The configuration is the configuration to either be applied, or switched to, or activated by the wireless device upon reception from the network of a L1/L2 inter-cell mobility command. The L1/L2 inter-cell mobility command comprises a lower layer signaling indicating to the wireless device the execution of L1/L2 inter-cell mobility to the L1/L2 inter-cell mobility candidate cell.

In particular embodiments, the configuration of the target L1/L2 inter-cell mobility candidate cell comprises at least one or more of: a beam configuration, wherein the beam configuration comprises a beam identifier; one or more SS index or one or more RS identifier;
a transmission configuration indication (TCI) state configuration, wherein the TCI state configuration comprises an associated RS identifier or an SS index; a quasi-colocation (QCL) configuration, wherein the QCL configuration comprises an associated RS identifier or an SS index; a TCI state configuration, wherein a TCI state configuration comprises an associated QCL configuration with an associated RS identifier or an SS index; a cell identifier; a CSI measurement configuration comprising one or more CSI resource configuration, wherein the CSI resource configuration indicates at least one SS index or at least one RS identifier to be measured when the wireless device operates in the target L1/L2 inter-cell mobility candidate cell; and/or frequency information of the SSs or the RSs being transmitted in the target cell (e.g., SSB frequency, CSI-RS initial frequency, CSI-RS number of physical resource blocks, CSI-RS offset to an absolute frequency like point A as defined in TS 38.331).

In particular embodiments, the configuration of the target L1/L2 inter-cell mobility candidate cell is generated by a candidate distributed unit (DU), wherein the candidate DU corresponds to a neighbor DU for a candidate cell of the neighbor DU or to a serving DU for a candidate cell of the neighbor DU.

In particular embodiments, the configuration of the target L1/L2 inter-cell mobility candidate cell comprises any of the configurations described with respect to any of the embodiments and examples described herein.

At step 1914, the wireless device performs CSI measurements on at least one of a SS (e.g., SSB) and/or at least one RS (e.g., CSI-RS) of the target L1/L2 inter-cell mobility candidate cell based on the at least one configuration of the target L1/L2 inter-cell mobility candidate cell.

In particular embodiments, performing the at least one CSI measurement on at least one SS or at least one RS is based on at least one frequency information of the SS or the RS of the L1/L2 inter-cell mobility candidate cell.

In particular embodiments, the at least one frequency information of the SS or the RS of the L1/L2 inter-cell mobility candidate cell is obtained by any one or more of: receiving a CSI measurement configuration in the message for a currently active serving cell; receiving a radio resource management (RRM) measurement configuration in the message, wherein the frequency information is associated to a measurement object that comprises a frequency information, e.g., SSB frequency; and/or receiving a configuration of a target L1/L2 inter-cell mobility candidate cell.

In particular embodiments, performing at least one CSI measurement on the SS or RS is based on at least one frequency information of the SS or the RS and by performing cell search to a cell of a cell identifier configured within the configuration of the target L1/L2 inter-cell mobility candidate cell, and upon detecting the cell, performing the at least one CSI measurement on an SS or an RS of the cell.

In particular embodiments, performing at least one CSI measurement on the SS or the RS is based on at least one frequency information of the SS or the RS for the SS or RS which are part of a beam configuration of the configuration of the target L1/L2 inter-cell mobility candidate cell.

In particular embodiments, performing at least one CSI measurement on the SS or the RS is based on at least one SS or RS configured as a quasi-colocation (QCL) source of a transmission configuration indication (TCI) state which is part of the configuration of the target L1/L2 inter-cell mobility candidate cell.

In particular embodiments, performing at least one CSI measurement on the SS or the RS is based on at least one SS or at least one RS configured in a CSI measurement configuration within the configuration of the target L1/L2 inter-cell mobility candidate cell.

In particular embodiments, performing at least one CSI measurement on the SS or the RS is based on at least one cell whose cell identifier is indicated in the configuration of the target L1/L2 inter-cell mobility candidate cell.

In particular embodiments, the wireless device may perform the measurements according to any of the embodiments and examples described herein.

At step 1916, the wireless device transmits a CSI report including information based on the CSI measurements to the network node. In particular embodiments, transmitting the CSI report including information based on the CSI measurements on the at least one SS and/or RS to the network node is based on one or more reporting criteria. The wireless device may transmit the one or more reporting criteria configured in a CSI reporting configuration.

Modifications, additions, or omissions may be made to method 1900 of FIG. 19. Additionally, one or more steps in the method of FIG. 19 may be performed in parallel or in any suitable order.

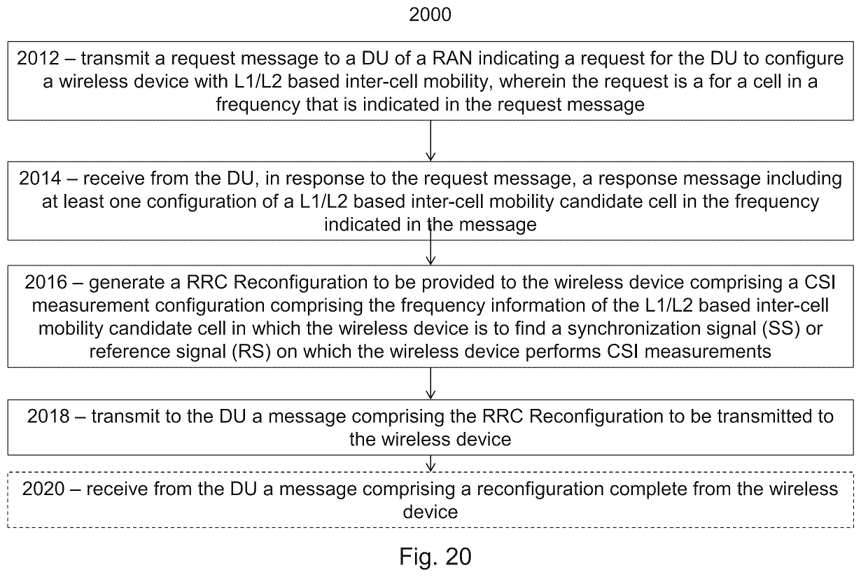

FIG. 20 illustrates a method performed by a network node central unit (CU), according to certain embodiments. In particular embodiments, one or more steps of FIG. 20 may be performed by network node 300 described with respect to FIG. 15. The network node operates as a CU of a RAN for configuring CSI measurements for a wireless device configured with L1/L2 based inter-cell mobility.

The method begins at step 2012, where the CU (e.g., network node 300) transmits a request message to a DU of the RAN indicating a request for the DU to configure the wireless device with L1/L2 based inter-cell mobility. The request is a for a cell in a frequency that is indicated in the request message.

At step 2014, the network node CU receives from the DU, in response to the request message, a response message including at least one configuration of a L1/L2 based inter-cell mobility candidate cell in the frequency indicated in the message. The configuration is described previously with respect to FIG. 19.

At step 2016, the network node CU generates a RRC Reconfiguration to be provided to the wireless device comprising a CSI measurement configuration comprising the frequency information of the L1/L2 based inter-cell mobility candidate cell in which the wireless device is to find a SS or RS on which the wireless device performs CSI measurements.

At step 2018, the network node CU transmits to the DU a message comprising the RRC Reconfiguration to be transmitted to the wireless device.

At step 220, the network node CU may receive from the DU a message comprising a reconfiguration complete from the wireless device.

Modifications, additions, or omissions may be made to method 2000 of FIG. 20. Additionally, one or more steps in the method of FIG. 20 may be performed in parallel or in any suitable order.

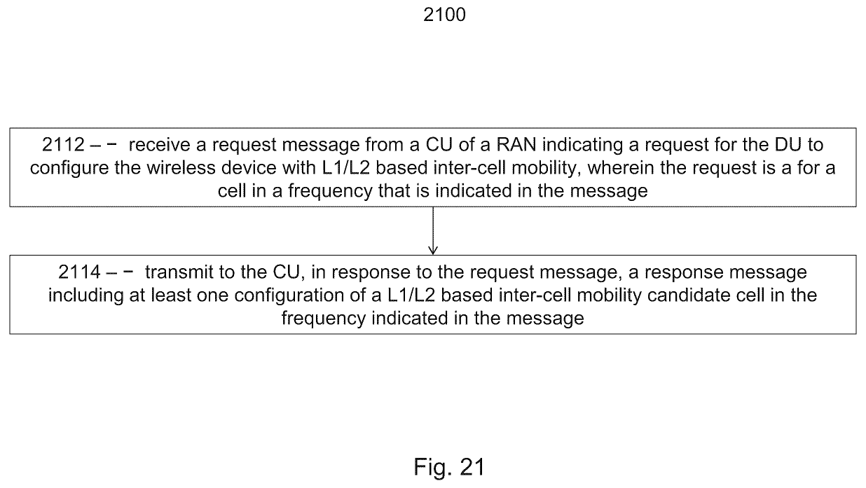

FIG. 21 illustrates a method performed by a network node distributed unit (DU), according to certain embodiments. In particular embodiments, one or more steps of FIG. 21 may be performed by network node 300 described with respect to FIG. 15. The network node operates as a DU of a RAN for configuring L1/L2 based inter-cell mobility for a wireless device (e.g., wireless device 200).

The method begins at step 2112, where the DU (e.g., network node 300) receives a request message from a CU of the RAN indicating a request for the DU to configure the wireless device with L1/L2 based inter-cell mobility. The request is a for a cell in a frequency that is indicated in the message.

At step 2114, the network node DU transmits to the CU, in response to the request message, a response message including at least one configuration of a L1/L2 based inter-cell mobility candidate cell in the frequency indicated in the message. The at least one configuration of a L1/L2 based inter-cell mobility candidate cell is to be used by the wireless device for performing CSI measurements on at least one SS and/or RS of the target L1/L2 inter-cell mobility candidate cell while the wireless device is still connected to the serving cell that is not the target L1/L2 inter-cell mobility candidate cell, in preparation for L1/L2 inter-cell mobility execution.

Modifications, additions, or omissions may be made to method 2100 of FIG. 21. Additionally, one or more steps in the method of FIG. 21 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device for performing channel state information (CSI) measurements for layer one (L1)/layer two (L2) inter-cell mobility, the method comprising:
receiving a message from a network node, the message comprising at least one configuration of a target L1/L2 inter-cell mobility candidate cell;
performing CSI measurements on at least one of a synchronization signal (SS) and a reference signal (RS) of the target L1/L2 inter-cell mobility candidate cell based on the at least one configuration of the target L1/L2 inter-cell mobility candidate cell; and
transmitting a CSI report including information based on the CSI measurements to the network node.

2. The method of claim 1, wherein performing the at least one CSI measurement on at least one SS or at least one RS is based on at least one frequency information of the SS or the RS of the L1/L2 inter-cell mobility candidate cell.

3. (canceled)

4. The method of claim 1, wherein the configuration of the target L1/L2 inter-cell mobility candidate cell comprises a configuration the wireless device uses in a target cell after L1/L2 inter-cell mobility execution, wherein the configuration is the configuration to either be applied, or switched to, or activated by the wireless device upon reception from the network of a L1/L2 inter-cell mobility command, wherein the L1/L2 inter-cell mobility command comprises a lower layer signaling indicating to the wireless device the execution of L1/L2 inter-cell mobility to the L1/L2 inter-cell mobility candidate cell.

5. The method of claim 1, wherein the configuration of the target L1/L2 inter-cell mobility candidate cell comprises at least one or more of:
a beam configuration, wherein the beam configuration comprises a beam identifier;
one or more SS index or one or more RS identifier;
a transmission configuration indication (TCI) state configuration, wherein the TCI state configuration comprises an associated RS identifier or an SS index;
a quasi-colocation (QCL) configuration, wherein the QCL configuration comprises an associated RS identifier or an SS index;
a TCI state configuration, wherein a TCI state configuration comprises an associated QCL configuration with an associated RS identifier or an SS index;
a cell identifier;
a CSI measurement configuration comprising one or more CSI resource configuration, wherein the CSI resource configuration indicates at least one SS index or at least one RS identifier to be measured when the wireless device operates in the target L1/L2 inter-cell mobility candidate cell;
frequency information of the SSs or the RSs being transmitted in the target cell.

6. The method of claim 1, wherein performing at least one CSI measurement on the SS or RS is based on at least one frequency information of the SS or the RS and by performing cell search to a cell of a cell identifier configured within the configuration of the target L1/L2 inter-cell mobility candidate cell, and upon detecting the cell, performing the at least one CSI measurement on an SS or an RS of the cell.

7. The method of claim 1, wherein performing at least one CSI measurement on the SS or the RS is based on at least one frequency information of the SS or the RS for the SS or RS which are part of a beam configuration of the configuration of the target L1/L2 inter-cell mobility candidate cell.

8. The method of claim 1, wherein performing at least one CSI measurement on the SS or the RS is based on at least one SS or RS configured as a quasi-colocation (QCL) source of a transmission configuration indication (TCI) state which is part of the configuration of the target L1/L2 inter-cell mobility candidate cell.

9.-10. (canceled)

11. The method of claim 1, wherein the configuration of the target L1/L2 inter-cell mobility candidate cell is generated by a candidate distributed unit (DU), wherein the candidate DU corresponds to a neighbor DU for a candidate cell of the neighbor DU or to a serving DU for a candidate cell of the neighbor DU.

12. A wireless device operable to perform channel state information (CSI) measurements for layer one (L1)/layer two (L2) inter-cell mobility, the wireless device comprising processing circuitry operable to:
receive a message from a network node, the message comprising at least one configuration of a target L1/L2 inter-cell mobility candidate cell;
perform CSI measurements on at least one of a synchronization signal (SS) and a reference signal (RS) of the target L1/L2 inter-cell mobility candidate cell based on the at least one configuration of the target L1/L2 inter-cell mobility candidate cell; and
transmit a CSI report including information based on the CSI measurements to the network node.

13. The wireless device of claim 12, wherein the processing circuitry is operable to perform the at least one CSI measurement on at least one SS or at least one RS based on at least one frequency information of the SS or the RS of the L1/L2 inter-cell mobility candidate cell.

14. (canceled)

15. The wireless device of claim 12, wherein the configuration of the target L1/L2 inter-cell mobility candidate cell comprises a configuration the wireless device uses in a target cell after L1/L2 inter-cell mobility execution, wherein the configuration is the configuration to either be applied, or switched to, or activated by the wireless device upon reception from the network of a L1/L2 inter-cell mobility command, wherein the L1/L2 inter-cell mobility command comprises a lower layer signaling indicating to the wireless device the execution of L1/L2 inter-cell mobility to the L1/L2 inter-cell mobility candidate cell.

16. The wireless device of claim 12, wherein the configuration of the target L1/L2 inter-cell mobility candidate cell comprises at least one or more of:
a beam configuration, wherein the beam configuration comprises a beam identifier;
one or more SS index or one or more RS identifier;
a transmission configuration indication (TCI) state configuration, wherein the TCI state configuration comprises an associated RS identifier or an SS index;
a quasi-colocation (QCL) configuration, wherein the QCL configuration comprises an associated RS identifier or an SS index;
a TCI state configuration, wherein a TCI state configuration comprises an associated QCL configuration with an associated RS identifier or an SS index;
a cell identifier;
a CSI measurement configuration comprising one or more CSI resource configuration, wherein the CSI resource configuration indicates at least one SS index or at least one RS identifier to be measured when the wireless device operates in the target L1/L2 inter-cell mobility candidate cell;
frequency information of the SSs or the RSs being transmitted in the target cell.

17. The wireless device of claim 12, wherein the processing circuitry is operable to perform at least one CSI measurement on the SS or RS based on at least one frequency information of the SS or the RS and by performing cell search to a cell of a cell identifier configured within the configuration of the target L1/L2 inter-cell mobility candidate cell, and upon detecting the cell, performing the at least one CSI measurement on an SS or an RS of the cell.

18. The wireless device of claim 12, wherein the processing circuitry is operable to perform at least one CSI measurement on the SS or the RS based on at least one frequency information of the SS or the RS for the SS or RS which are part of a beam configuration of the configuration of the target L1/L2 inter-cell mobility candidate cell.

19. The wireless device of claim 12, wherein the processing circuitry is operable to perform at least one CSI measurement on the SS or the RS based on at least one SS or RS configured as a quasi-colocation (QCL) source of a transmission configuration indication (TCI) state which is part of the configuration of the target L1/L2 inter-cell mobility candidate cell.

20.-21. (canceled)

22. The wireless device of claim 12, wherein the configuration of the target L1/L2 inter-cell mobility candidate cell is generated by a candidate distributed unit (DU), wherein the candidate DU corresponds to a neighbor DU for a candidate cell of the neighbor DU or to a serving DU for a candidate cell of the neighbor DU.

23. A method performed by a network node operating as a central unit (CU) of a radio access network (RAN) for configuring channel state information (CSI) measurements for a wireless device configured with L1/L2 based inter-cell mobility, the method comprising:
transmitting a request message to a DU of the RAN indicating a request for the DU to configure the wireless device with L1/L2 based inter-cell mobility, wherein the request is a for a cell in a frequency that is indicated in the request message;
receiving from the DU, in response to the request message, a response message including at least one configuration of a L1/L2 based inter-cell mobility candidate cell in the frequency indicated in the message;
generating a Radio Resource Control (RRC) Reconfiguration to be provided to the wireless device comprising a CSI measurement configuration comprising the frequency information of the L1/L2 based inter-cell mobility candidate cell in which the wireless device is to find a synchronization signal (SS) or reference signal (RS) on which the wireless device performs CSI measurements; and
transmitting to the DU a message comprising the RRC Reconfiguration to be transmitted to the wireless device.

24. The method of claim 23, further comprising receiving from the DU a message comprising a reconfiguration complete from the wireless device.

25. The method of any one of, wherein the at least one configuration of the target L1/L2 inter-cell mobility candidate cell comprises at least one or more of:
a beam configuration, wherein the beam configuration comprises a beam identifier;
one or more SS index or one or more RS identifier;
a transmission configuration indication (TCI) state configuration, wherein the TCI state configuration comprises an associated RS identifier or an SS index;
a quasi-colocation (QCL) configuration, wherein the QCL configuration comprises an associated RS identifier or an SS index;
a TCI state configuration, wherein a TCI state configuration comprises an associated QCL configuration with an associated RS identifier or an SS index;
a cell identifier;
a CSI measurement configuration comprising one or more CSI resource configuration, wherein the CSI resource configuration indicates at least one SS index or at least one RS identifier to be measured when the wireless device operates in the target L1/L2 inter-cell mobility candidate cell;
frequency information of the SSs or the RSs being transmitted in the target cell.

26. A network node capable of operating as a central unit (CU) of a radio access network (RAN) for configuring channel state information (CSI) measurements for a wireless device configured with L1/L2 based inter-cell mobility, the network node comprising processing circuitry operable to:
transmit a request message to a DU of the RAN indicating a request for the DU to configure the wireless device with L1/L2 based inter-cell mobility, wherein the request is a for a cell in a frequency that is indicated in the request message;
receive from the DU, in response to the request message, a response message including at least one configuration of a L1/L2 based inter-cell mobility candidate cell in the frequency indicated in the message;
generate a Radio Resource Control (RRC) Reconfiguration to be provided to the wireless device comprising a CSI measurement configuration comprising the frequency information of the L1/L2 based inter-cell mobility candidate cell in which the wireless device is to find a synchronization signal (SS) or reference signal (RS) on which the wireless device performs CSI measurements; and
transmit to the DU a message comprising the RRC Reconfiguration to be transmitted to the wireless device.

27. The network node of claim 26, the processing circuitry further operable to receive from the DU a message comprising a reconfiguration complete from the wireless device.

28. The network node of any one of, wherein the at least one configuration of the target L1/L2 inter-cell mobility candidate cell comprises at least one or more of:
a beam configuration, wherein the beam configuration comprises a beam identifier;
one or more SS index or one or more RS identifier;
a transmission configuration indication (TCI) state configuration, wherein the TCI state configuration comprises an associated RS identifier or an SS index;
a quasi-colocation (QCL) configuration, wherein the QCL configuration comprises an associated RS identifier or an SS index;
a TCI state configuration, wherein a TCI state configuration comprises an associated QCL configuration with an associated RS identifier or an SS index;
a cell identifier;
a CSI measurement configuration comprising one or more CSI resource configuration, wherein the CSI resource configuration indicates at least one SS index or at least one RS identifier to be measured when the wireless device operates in the target L1/L2 inter-cell mobility candidate cell;
frequency information of the SSs or the RSs being transmitted in the target cell.
